(19) United States
(12) Patent Application Publication
(10) Pub. No.: US 2007/0009163 A1
(43) Pub. Date: Jan. 11, 2007

(54) Image transmitting apparatus and image receiving apparatus

(75) Inventors: Hisashi Sasaki, Kawasaki-Shi (JP); Haruhiko Okumura, Fujisawa-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/483,277

(22) Filed: Jul. 10, 2006

(30) Foreign Application Priority Data
Jul. 11, 2005 (JP) 2005-201287

(51) Int. Cl. G06K 9/36

(52) U.S. Cl. 382/238

(57) ABSTRACT

An image transmission apparatus has a difference calculator configured to calculate a difference between actual image data and current predicted data based on previous data, a quantizer configured to generate quantized difference data obtained by quantizing the difference, a quantization characteristic determinator configured to determine a quantization characteristic corresponding to the quantizer based on pixel values of a plurality of neighbor pixels located in surroundings of a current pixel, and a encoder configured to generate code word to be transmitted via a least single transmission line based on the quantized difference data.

### CROSS REFERENCE TO RELATED APPLICATIONS

This application is based upon and claims the benefit of priority from the prior Japanese Patent Application No. 2005-201287, filed on Jul. 11, 2005, the entire contents of which are incorporated herein by reference.

### BACKGROUND OF THE INVENTION

1. Field of the Invention

The present invention relates to an image transmitting apparatus and an image receiving apparatus for transmitting or receiving image data.

2. Related Art

In order to deal with high resolution and high quality image data, it is necessary to transmit massive image data. This massive data transfer in recent years inevitably causes an EMI problem.

The number of pixels in pixel data dealt by electronic appliances has been increasing year by year. The number is estimated to increase at a rate of 1.6 times per three years based on its tendency up to date. The number of pixels and a transmission frequency of data are almost in proportion to each other. EMI noise increases in proportion to a square of frequency. Therefore, the EMI noise increases at a rate of 1.6 *1.6=2.56 times per three years, which is a square of the increase of the pixel number of 1.6 times per three years.

Many data transmission techniques are proposed to cope with EMI such as RSDS (Reduced Swing Differential Signaling), mini-LVDS (Low Voltage Differential Signaling), CMADS (Current Mode Advanced Differential Signaling), whisper BUS, Mobile-CMADS, MSDL (Mobile Shrink Data Link), MPL (Mobile Pixel Link), MVL (Mobile Video Interface). Some papers are reported in the SID: a paper on RSDS by Lee (see Integrated TFT-LCD Timing Controllers with RSDS Column Driver Interface, SID Digest 6.2, 1999), a paper on CMADA by Yusa (see High-Speed I/F for TFT-LCD Source Driver IC by CMADS, SID Digest. 9.4, 2001), and a paper by McCarney (see Whisper BUS: An Advanced Interconnect Link for TFT Column Driver Data, SID Digest. 9.3, 2001). In addition, an article on comparative analysis has collectively discussed on several introductions of serial interfaces for cellular phone (see Nikkei Electronics, Mar. 15, 2004, p 128-130).

Furthermore, cellular phones have several extensions of the serial interfaces: Mobile-CMADS, MSDL, MPL, and MVI. In the extensions, circuit improvements successfully (but fortunately) suppressed EMI since the size of pixels is still small at the present time. However, theses are temporary remedy. As the size of pixels will increase further from now on, the size of data will rapidly increase too. This rapid increase implies that the circuit is requested to operate at higher frequency, and the cost of circuit is becoming more intolerant. Therefore, the improvements of circuit will reach critical limit in the near future.

Power consumption is an important factor in electronic devices especially in the case that the device is power-supplied by batteries in cellular phone. In addition, higher speed operation of circuit is not desirable. Hence, we need another new technology, but the technology should be consistent with the conventional technology. This means that solutions to be investigated should be “add-on approach” based on the conventional circuit-related improvements. Considering this strategy, compression of data size and reduction of data transition will be cited as conventional technology relating to the present invention. They will be described below.

Japanese Patent Laid-Open Publication No. 366107/2003 includes the transition reducing technology such as an alternative bit inversion method, and the size reducing technology such as a Huffman coding, an one-dimensional compressing method, and an arithmetic compression method. This official gazette reported that size of data reduction is not always attained to ½, and its data size changes heavily depending on data itself. This dependency requests an adjustment of transmission frequency according to data size in order to transfer data without loss. An extra control circuit is not desirable in order to implement the adjustment.

In addition, Japanese Patent Laid-Open Publication No. 202760/2002 includes a technology, which reduces data transition using popular bus inversion technique: when majority of data changes, original data is intentionally bit-inverted to reduce data transition.

These official gazettes treat data as a “general number” to be transferred in a bus. A characteristic of image data is not utilized well. For this reason, compression ratio is not so high.

Japanese Patent Laid-Open Publication No. 152129/2000 includes a technology of utilizing addition and subtraction to reduce data transition. In this official gazette, a numerical conversion reduces transition count: for instance, an operation “add one” is such a conversion. This conversion transforms a transition “0000 to 1111” to a transition “0001 to 0000”, which reduces transition count (4 transitions to 1 transition). Since this official gazette also treats “general data”, not specialized for image data, image data cannot be processed effectively from the aspect of utilization of statistical characteristic of image.

In addition, an FV coding method is known, which performs bus inversion with dynamic monitoring of data frequency (see Jun Yang, Rajiv Gupta, FV Encoding for low-power Data I/O, IEEE, ISLPED 2001). This technique does not intentionally utilize the statistical characteristic of images as data.

Now, our survey will proceed to the technologies to utilize statistical characteristic of images. Japanese Patent Laid-Open Publication No. 44017/2003 (see patent document 4) includes a method to reduce size of data to be transferred. When a current data has same value as a 1H-previous data, the re-usage of saved 1H-previous data do not request the transfer of current data. This non-transmission works equivalently as a reduction of data size. However, since a probability in an actual image to have same value as 1H-previous is ten to twenty percent on average, the above non-transmission attains at most twenty percent reduction. Hence, it is impossible to obtain so large enough effect that EMI noise is fully reduced.

In addition, a VDE method is proposed, which reduces EMI noise using “1H” correlation of an image (see patent documents 5, 6 and non-patent document 6). In the techniques, “1H” prediction, “1V” prediction, and a spatial predictor are so simple that its resultant performance is insufficient. In addition, the VDE method simply transfers differential data as it is, and the VDE method has no channel coding to reduce a transition count on a channel. For this reason, good performance can be achieved only when correlation is extremely high, like a PC screen image artificially generated. Hence, its performance is not good for natural images such as a TV screen image. The inventors try to improve performance on natural images such as on a TV screen image as a target by using the latest technique of image data compression. The data compression techniques will be described below.

ISO standard FCD14495 is a popular technology known as JPEG-LS (lossless) at the present time. JPEG-LS is one of the most advanced data compression technology without data loss (lossless). The JPEG-LS technology uses DPCM (Differential Pulse Cod Modulation). MED (Median edge detector) and GAP (gradient-adjusted predictor) are well known as DPCM prediction technology related to image data. As GAP needs 2H memory (memory for two horizontal lines) and hardware circuit size is large, MED is discussed to use as DPCM hereinafter because MED needs only 1H memory. But, prioritizing of area-efficient implementation may select another choice if necessary, because the other predictor with rather inferior performance may have smaller hardware. Therefore, we have no intention to restrict ourselves to only MED technology. Under such understanding, MED-related conventional arts will be surveyed as follows.

MED has been further improved in recent years. There is a modified MED technology to improve performance with diagonal edges (see Revising the JPEG-LS prediction scheme, IEE Proc. Visual Image Signal Processing, Vol. 147, No. 6, December 2000, pp. 575-580). In addition, there is another modified MED technology to improve performance with different prediction scheme (see Two Low Cost Algorithms for Improved Diagonal Edge Detection in JPEG-LS, IEEE Transaction on Consumer Electronics, Vol. 47, No. 3, August 2001, pp. 466-473, and Toward improved prediction accuracy in JPEG-LS, SPIE Optical Engineering, 41(2) 335-341, February 2002.) Yet another modified MED with higher performance is proposed (see Improvements to JPEG-LS via diagonal edge based prediction, Visual Communications and Image Processing 2002, Proceedings of SPIE, Vol. 4671 (2002).) All these conventional MEDs are used for the purpose of data compression. They are not used for the different purposes: reduction of EMI noise and reduction of wiring count.

Next, conventional technologies to utilize image entropy will be explained to quickly survey related technologies, because they are generally helpful to understand the present invention. Several data compression technologies are known, which utilize entropy in order to reduce size of encoded codes. These include technologies such as Golomb codes, arithmetic coding, and Huffman coding (see David Salomon, Data Compression, 3rd Edition 2004, Springer Verlag.) In recent years, there are other two technical directions. One is an idea of reducing a transition count in data. Another is an idea of reducing amplitude of signal.

First, a survey will be started from reduction technology of transition count. There are three techniques concerning EMI improvement for DVI (see Digital Visual Interface, DVI Revision 1.0. 02 April 1999. Digital Display Working Group. http://www.ddwg.org): A first is Chromatic encoding technique by Cheng and others (see We-Chung Cheng and Massound Pedram Chromatic Encoding: a Low Power Encoding Technique for Digital Visual Interface IEEE DATE 2003 session 6.3.); a second is Differential Bar Encoding technique by Bocca and others (see Alberto Bocca, Sabino Salerno, Enrico Macii, Massimo Poncino, Energy-Efficient Bus Encoding for LCD Displays, GLSVLSI' 04.); and a third is Limited Intra-Word Transition Codes (Sabino Salerno, Alberto Bocca, Enrico Macii, Massimo Poncino. Limited Intra-Word Transition Codes: An Energy-Efficient Bus Encoding for LCD Display Interfaces, IEEE/ACM ISLPED 2004, session 7.4.). Further, Quiet coding by Sasaki for the purpose of an intra panel interface, (technique added to Japanese Patent Laid-Open Pub. No. 100545/2004, and Hisashi Sasaki, Tooru Arai, Masayuki Hachiuma, Akira Masuko, Takashi Taguchi, Quiet code: A Transition-Minimized Code to Eliminate Inter-Word Transition for an LCD-Panel Module Interface, SID Symposium 2005, P-47.). As shown above, four variations to reduce transition count are already known.

On the other hand, there is a multi-valued image entropy coding (MVIEC) as technology of using entropy to reduce amplitude (Japanese Patent Laid-Open Pub. No. 100545/2004 and Hisashi Sasaki, Tooru Arai, Masayuki Hachiuma, Akira Masuko, Takashi Taguchi, Multi-Valued Image Entropy Coding for Input-Width Reduction of LCD Source Drivers, SID Asia Display/IMID 2004). Only single technique is known as such a technique. The image entropy encoder adapts a modulo reduction technique, which converts 9-bit prediction difference data width to 8-bit data (before multi-valuation of channel coding). Therefore, modulo reduction reduces the increased data bit width due to generation of a prediction difference. That contributes to avoid an extra hardware including PLL circuit, thereby to reduce size of the hardware. Affect caused by modulo reduction is extremely small in probability distribution of difference signals. Therefore, performance of an entropy encoder is not deteriorated almost at all. The second technique is channel coding characterized by amplitude reducing. By reducing average amplitude, performance of codes is improved.

Generally for a data compressing technique, codes are specially designed for individual purposes: reduction of transition count and reduction of average amplitude. Therefore, both purposes cannot be solved simultaneously and single purpose needs to be selected. Further improvement of performance is desired to achieve by considering plurality of optimization. In the case of lossless, code allocation has no flexibility to mitigate multiple purposes simultaneously because lossless requires many code words in order to realize lossless. The multiple purposes will not be fulfilled simultaneously until lossy or near-lossless technologies are permitted.

In the conventional near-lossless data compressing techniques, a compression rate is improved by quantization. In the past, quantization was used only for the data compression. Instead of improving a compression rate, by providing flexibility in code allocation, the present invention will propose that quantization desirably improve or simultaneously add various capabilities: reduction of number (width) of lines, reduction of its EMI noise, reduction of its power consumption, reduction of number (level) of multi-valuation, improvement in SNR at discrimination point, and enhancement of an error correcting capability.

### SUMMARY OF THE INVENTION

According to one embodiment of the present invention, a n image transmission apparatus comprising:

a difference calculator configured to calculate a difference between actual image data and current predicted data based on previous data;

a quantizer configured to generate quantized difference data obtained by quantizing the difference;

a quantization characteristic determinator configured to determine a quantization characteristic corresponding to the quantizer based on pixel values of a plurality of neighbor pixels located in surroundings of a current pixel; and

a encoder configured to generate code word to be transmitted via a least single transmission line based on the quantized difference data.

According to one embodiment of the present invention, an image receiving apparatus, comprising:

a decoder configured to receive code word transmitted via at least single transmission line, perform decoding process and generate quantized difference data;

an inverse quantizer configured to calculate a difference between actual image data and predicted data predicted by reconstructed image data corresponding to the actual image data based on the quantized difference data;

an inverse quantization characteristic determinator configured to determine inverse quantization characteristic by the inverse quantizer based on pixel values of a plurality of neighbor pixels located in surroundings of a current pixel; and

a image reconstructor configured to reconstruct the reconstructed image data based on the difference.

According to one embodiment of the present invention, an image transmission method which transmits image data from an image transmission apparatus to an image receiving apparatus, comprising:

calculating a difference between actual image data and current predicted data based on previous data;

generating quantized difference data obtained by quantizing the difference based on quantization characteristic determined based on pixel values of a plurality of neighbor pixels located in surroundings of a current pixel;

generating code word to be transmitted via at least single transmission line based on the quantized difference data;

determining an inverse quantization characteristic based on pixel values of a plurality of neighbor pixels located in surroundings of the current pixel to convert the quantized difference data into a difference between actual image data and predicted data predicted by reconstructed image data corresponding to the actual image data,

wherein the reconstructed image data is generated based on the difference.

### BRIEF DESCRIPTION OF THE DRAWINGS

FIG. 1 is a block diagram showing an outlined configuration of an image transfer system according to an embodiment of the present invention;

FIG. 2 is a diagram for illustrating processing operation of the quantization characteristic determinator 14 and the inverse quantization characteristic determinator 24;

FIG. 3 is a flowchart showing an instance of processing operation of the quantization characteristic determinator 14 and the inverse quantization characteristic determinator 24 of FIG. 1;

FIG. 4 is a flowchart showing a procedure of the quantizer 12 having a particular quantization characteristic (0123 characteristic) selected at step S3 in FIG. 3;

FIG. 5 is a flowchart showing a procedure of the quantizer 12 having a particular quantization characteristic (01312m2 characteristic) performed at step S3 in FIG. 3;

FIG. 6 is a flowchart showing a procedure of the quantizer 12 having a particular quantization characteristic (0714 characteristic) performed at step S4 in FIG. 3;

FIG. 7 is a diagram showing a data form of image data sent out from the image transmitting apparatus 1 onto the transmission line 3;

FIG. 8 is a diagram showing a code table corresponding to an encoder 13;

FIG. 9 is a diagram showing an analyzed result of images subjected to encoding by a technique of the embodiment for various images A to E;

FIG. 10 is a diagram showing a statistic result of average amplitude of the images A to E;

FIG. 11 is a diagram showing a statistic result of PSNR of the images A to E;

FIG. 12 is a diagram showing a result of regression analysis of average amplitude and PSNR of images A to E;

FIG. 13 is diagram showing an instance of a code table;

FIG. 14 is a diagram showing a code table of FIG. 13 in which code word with a value 3 is removed;

FIG. 15 is a diagram showing an instance of a code table having code word consisting of two 5-valuated digits Δ1Δ0;

FIG. 16 is a diagram showing correlation between average amplitude and PSNR of two coding “qOAC3h”, “qOAC5h”;

FIG. 17 is a data transmission timing diagram for four cycles;

FIG. 18 is a diagram of the code table of FIG. 6 with information on the count of data transitions added;

FIG. 19 is a diagram showing a code table for encoding to minimize the transition count;

FIG. 20 is a diagram showing a list of code word which is not used in the code table of FIG. 19;

FIG. 21 is a diagram of FIG. 16 with an analyzed result of code word “qQuiet” of FIG. 19 added;

FIG. 22 is a diagram showing a code table according to a fifth embodiment;

FIG. 23 is a block diagram showing an outlined configuration of an image transfer system according to the fifth embodiment;

FIG. 24 is a diagram for illustrating a processing instance of a modulo part 17 in the case where a previous code word ends by 0;

FIG. 25 is a diagram for illustrating a processing instance of a difference detecting part 26 that received data generated in FIG. 24;

FIG. 26 is a diagram for illustrating a processing instance of the modulo part 17 in the case where a previous code word ends by 1;

FIG. 27 is a diagram for illustrating a processing instance of the difference detecting part 26 that received data generated in FIG. 26;

FIG. 28 is a block diagram showing an outlined configuration of the image transfer system according to a sixth embodiment of the present invention;

FIG. 29 is a diagram showing a code table of the sixth embodiment;

FIG. 30 is a diagram showing an analyzed result by the sixth embodiment;

FIG. 31 is a diagram showing another analyzed result of the sixth embodiment;

FIG. 32 is a diagram showing an instance of a code table in which average amplitude is added as a performance index;

FIG. 33 is a diagram showing an instance of a code table in which average amplitude is improved to 0.162;

FIG. 34 is a diagram showing another analyzed result of the sixth embodiment;

FIG. 35 is a diagram showing an instance of a code table in which C1 prefix code are used;

FIG. 36 is a diagram showing an analyzed result in the case where data is transferred by using the code table of FIG. 35;

FIG. 37 is a diagram showing a code table which is the improved code table of FIG. 35;

FIG. 38 is a diagram showing an analyzed result in the case where the transition count is reduced;

FIG. 39 is a diagram showing a transfer format of an eighth embodiment;

FIG. 40A-40B are diagrams showing an instance of the code table of the eighth embodiment;

FIG. 41 is a flowchart showing an instance of processing operation of the quantization characteristic determinator 14 according to a ninth embodiment; and

FIG. 42 is a diagram showing a code table including a part of multi-valued C1 prefix code.

### DETAILED DESCRIPTION OF THE INVENTION

Embodiments of the present invention will be described below with reference to the drawings.

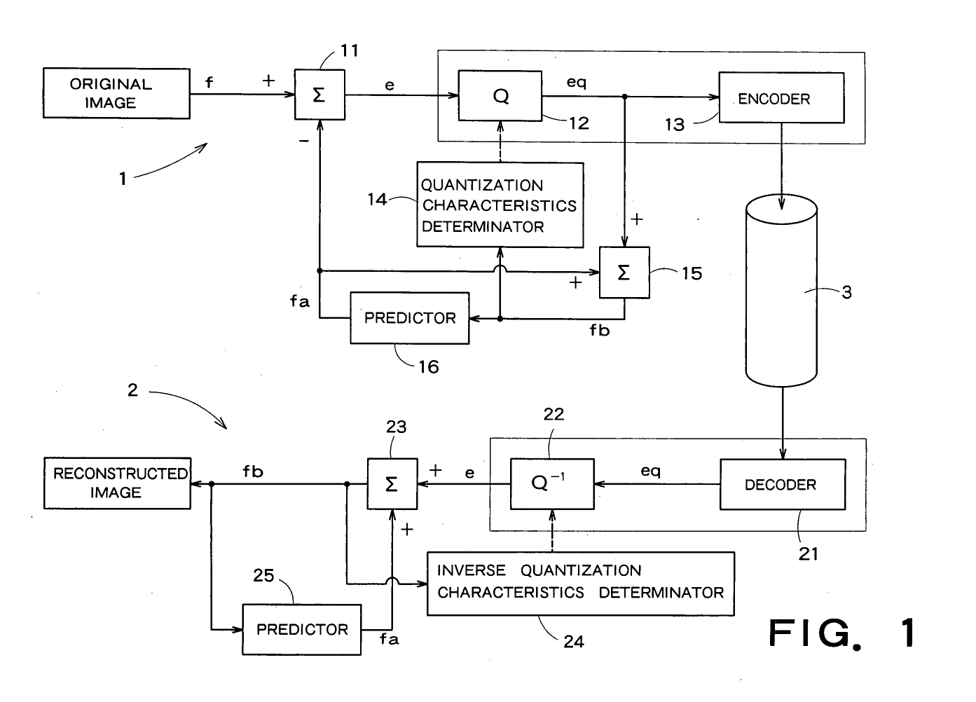

FIG. 1 is a block diagram showing an outlined configuration of an image transfer system according to an embodiment of the present invention. The image transfer system of FIG. 1 includes an image transmitting apparatus 1, an image receiving apparatus 2, and a transmission line 3 connected between the above apparatus for transmitting and receiving image data.

The image transfer system of FIG. 1 is not limited to be applied to each display device such as an LCD (Liquid Crystal Display), a TV, a PDP (Plasma Display Panel), and an OLED, and can be widely applied to the cases where image data is digitally transmitted to a camera or a cellular phone. The system can also be applied to the case of transferring image data between chips such as in a memory or a CPU. The image transmitting apparatus 1 can be provided with a capability of receiving image data and the image receiving apparatus 2 can be provided with a capability of transmitting image data so that image data is transmitted and received in both directions.

The image transmitting apparatus 1 in FIG. 1 includes a first difference image generator 11, a quantizer 12, an encoder 13, a quantization characteristic determinator 14, a first image reconstructor 15 and a first image predictor 16.

The first difference image generator 11 calculates difference image data between an actual image data and a predicted data based on previous data. The quantizer 12 generates a quantized difference data, which is obtained by quantizing the difference image data generated by the first difference image generator 11. The encoder 13 generates a code word based on the quantized difference data. The code word is sent out to the transmission line 3. The first image reconstructor 15 generates reconstructed image data by adding the quantized difference data to the predicted data. The quantization characteristic determinator 14 determines quantization characteristic of the quantizer 12 based on values of neighbor pixels. The first image predictor 16 generates the predicted data based on the reconstructed image data.

The image receiving apparatus 2 in FIG. 1 includes a decoder 21, an inverse quantizer 22, a second image reconstructor 23, an inverse quantization characteristic determinator 24, and a second image predictor 25 (a replica of the predictor 16).

The decoder 21 generates a quantized difference data by decoding the received code word. The inverse quantizer 22 generates a second difference image data between the second quantized difference data and a second predicted data, which is predicted according to a second previous image data and a second actual image data. The second image reconstructor 23 generates the second reconstructed image data corresponding to actual image data, based on the second difference image data. The inverse quantization characteristic determinator 24 determines inverse quantization characteristic of the inverse quantizer 22 based on the second reconstructed image data.

The difference image data “e” has quite steep distribution centering on “0” by strong spatial correlation of images. So, the data transmission has been enabled advantageous because it exploits the potentiality of such statistic deviation with encoding the difference image data “e”.

If image data is eight bits, for instance, the value of difference image data falls within the range from −255 to +255. Total 255*2+1=511 codes need to be prepared by mapping one to one from −255 to +255, in order to prevent any information loss on the image.

Even if the information is not perfect with having a little partial loss, human eyes don't mind wrong image without uncomfortable feeling. According to such visual nature, lossy image coding is widely accepted in public. So, we will accept a loss by quantization in this invention.

Thus, although the difference value “e” is quantized with causing loss, image is transferred without giving uncomfortable feeling by the quantization function to be described later. With transferring such a quantized difference value, the total number of code word will be reduced, and therefore favorable code word will be selected in order to improve performance. The image generated by such quantized difference is reconstructed as follows: a predicted value is added to a quantized difference value. In this reconstruction, the predicted value is calculated from the already reconstructed previous image.

In such a manner, “causal prediction” is always used in the embodiments. In the past, from the viewpoint of image data compression, coding was variable-length coding such as Golomb code, arithmetic code, Huffman code: the data size was tried to compress by allocating small-size code first to the data with high occurrence frequency. The invention will propose such sort of channel coding, especially characterized by an exploitation of DPCM scheme. The DPCM is exploited not only from the aspect of data size but also from another performance aspect in reduction of transition count and signal amplitude and so on.

The following equations from (1) to (4) give the processing of the embodiment, where “e” denotes difference image data, “eq” denotes quantized difference data, “f” denotes actual image data, “fa” denotes predicted data, and “fb” denotes reconstructed image data.
e=f−fa . . . (1)
eq=Q(e) . . . (2)
fb=fa+eq . . . (3)
fa=Prediction(fb) . . . (4)

In the image transfer system shown in FIG. 1, the encoder 13 and the decoder 21 are especially characterized by their code table configurations. In the embodiment, as image data is quantized and then encoded, image quality is slightly degraded. However, by admitting such degradation, encoding will enjoy more flexibility to select its code words, and therefore some performances of data transmission is improved.

Generally, the wider a quantization step is, the more degraded an image is. At the same time, in the wider step, average amplitude becomes lower and average transition count becomes smaller: performance of data transmission is improved. That is, quantization step should desirably be wider for better performance. When the step is too wide, degradation of image quality such as “pseudo contour” becomes visible. Pseudo contour is a phenomenon to detect false visual strip, for instance, which is typically appeared in an image of degraded gradation of blue sky.

When quantization is performed equally on an entire image, the appearance of pseudo-contour differs depending on individual visual objects found in image. Therefore, quantization step should be determined for each pixel adaptively to its context, a state of neighborhood around the pixel.

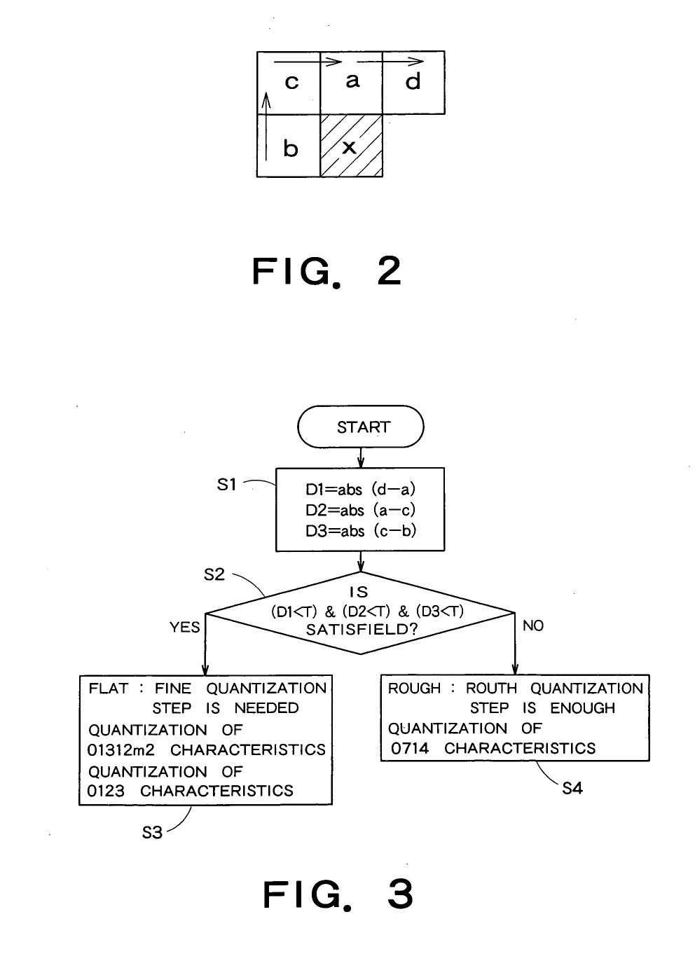

In the embodiment, the quantization characteristic determinator 14 and the inverse quantization characteristic determinator 24 of FIG. 1 correspondingly determine their quantization step. FIG. 2 shows the pixel configuration in order to describe the processing of the quantization characteristic determinator 14 and the inverse quantization characteristic determinator 24. Consider a pixel “x” in FIG. 2 as “current” where the adjective “current” means that it is currently processed. The quantization step of the current pixel “x” is determined by considering its context: the neighbor pixels “a”, “b”, “c” and “d” surround the current pixel “x”. Here, the values for image data of the pixels “a” to “d” are referred to as “a” to “d” for simplicity (that is, its name and value is intentionally confused). The quantization characteristic determinator 14 extracts the image data of the pixels “a” to “d” from the inputted original image data. The inverse quantization characteristic determinator 24 extracts the image data of the corresponding pixels “a” to “d” from the reconstructed image data.

FIG. 3 is a flowchart showing an instance of processing of the quantization characteristic determinator 14 and the inverse quantization characteristic determinator 24 of FIG. 1. First, detect the differences between pixels “a” to “d” surrounding the pixel “x” (step S1). Here, the absolute values of differences are detected according to the following equations (5) to (7).
D1=abs(d−a) . . . (5)
D2=abs(a−c) . . . (6)
D3=abs(c−b) . . . (7)

Next, determine its context: whether each of the differences D1, D2 and D3 is less than a given threshold T (step S2). If the determination result at the step S2 is YES, the values of the pixels “a” to “d” are close to one another: the analyzed part of image is considered as “flat”. Therefore, fine quantization characteristic is selected for the quantizer 12: the quantization step is smallest in order to accurately detect small changes in the flat part of image (step S3). At the step S3, the quantizer 12 will select a particular quantization characteristic such as a 0123 characteristic, a 01312m2 characteristic and so on: its details will be explained later,.

At the step S2, if any one of the differences D1 to D3 exceeds the threshold T, the current part of image is considered as rough. Therefore, the quantizer 12 will select a coarse quantization characteristic such as a 0714 characteristic (to be described later): in this case, the quantization step is wide (step S4).

In the processing of FIG. 3, more explanation is supplemented for the above determination process: the threshold T determines the context surrounding the current pixel. It determines the context in the meaning of probability, but not in the meaning of logical inference. Therefore, even when fine quantization characteristic is selected, you should be ready to handle the case that differences D1 to D3 are large.

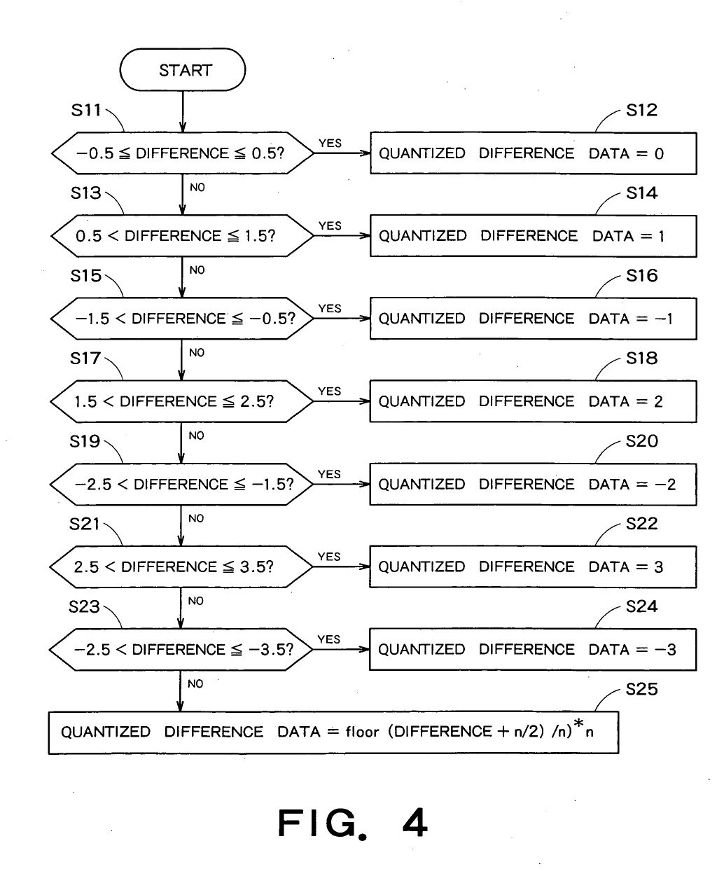

FIG. 4 is a flowchart showing a procedure of the quantizer 12, where a particular quantization characteristic (0123 characteristic) is selected at the step S3 in FIG. 3. First, the step S11 determines whether −0.5≦difference ≦0.5. If the determination result is YES, select the step 12 “quantized difference data =0”.

If the step S11 returns NO, the step S13 determines whether 0.5≦ difference ≦1.5. If the determination result is YES, select the step S14 “quantized difference data =1”. If the determination result is NO, the step S15 determines whether −1.5≦difference ≦0.5. If YES, select the step S16 “quantized difference data =−1”.

If the step S15 returns NO, the step S17 determines whether 1.5≦difference ≦2.5. If the determination result is YES, select the step S18 “quantized difference data =2”. If NO, the step S19 determines whether −2.5≦difference ≦−1.5. If YES, select the step S20 “quantized difference data =−2”.

If the step S19 returns NO, the step S21 determines whether 2.5≦difference ≦3.5. If YES, select the step S22 “quantized difference data =3”. If NO, the step S23 determines whether −3.5≦difference ≦−2.5. If YES, select the step S24 “quantized difference data =−3”.

If the step S23 returns NO, the quantized difference data is given by the following equation (8) (Step S25).
Quantized difference data =floor((difference +n/2)/n)*n . . . (8)

The equation (8) gives the quantized difference data for the step n=31.

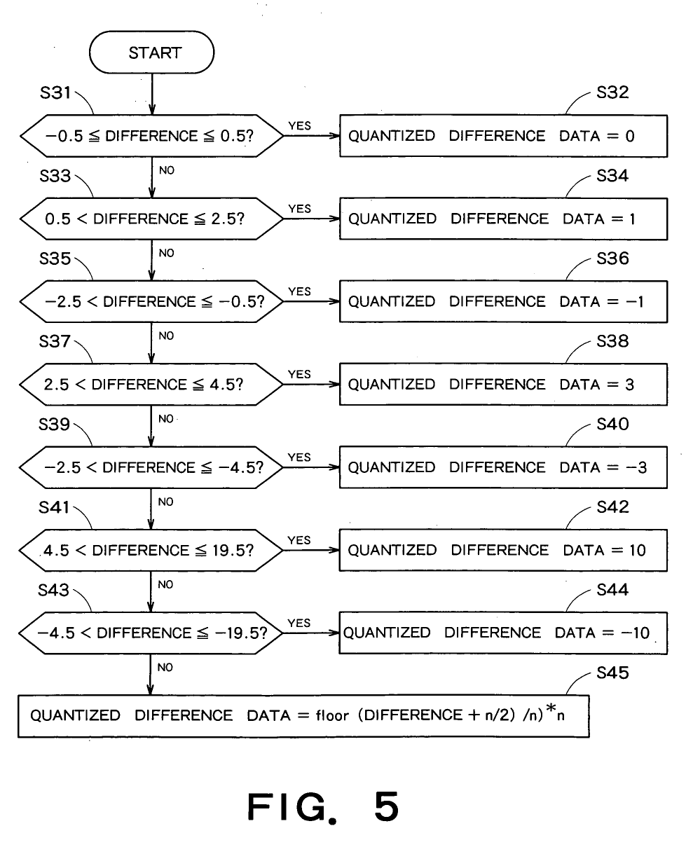

FIG. 5 is a flowchart showing a procedure of the quantizer 12, where a particular quantization characteristic (01312m2 characteristic) is selected at the step S3 in FIG. 3. First, the step S31 determines whether −0.5≦difference ≦0.5. If YES, select the step S32 “quantized difference data =0”.

If the step S31 returns NO, the step S33 determines whether 0.5≦difference ≦1.5. If YES, select the step S34 “quantized difference data =1”. If NO, the step S35 determines whether −1.5≦difference ≦0.5. If YES, select the step S36 “quantized difference data =−1”.

If the step S35 returns NO, the step S37 determines whether 1.5≦difference ≦4.5. If YES, select the step S38 “quantized difference data =3”. If NO, the step S39 determines whether −4.5≦difference ≦−1.5. If YES, select the step S40 “quantized difference data =−3”.

If the step S37 returns NO, the step S41 determines whether 4.5≦difference ≦19.5. If YES, select the step S42 “quantized difference data =12”. If NO, the step S43 determines whether −19.5≦difference ≦−4.5. If YES, select the step S44 “quantized difference data =−12”.

If the step S43 returns NO, the quantized difference data is given by the step =31 according to the above equation (8) (Step S45).

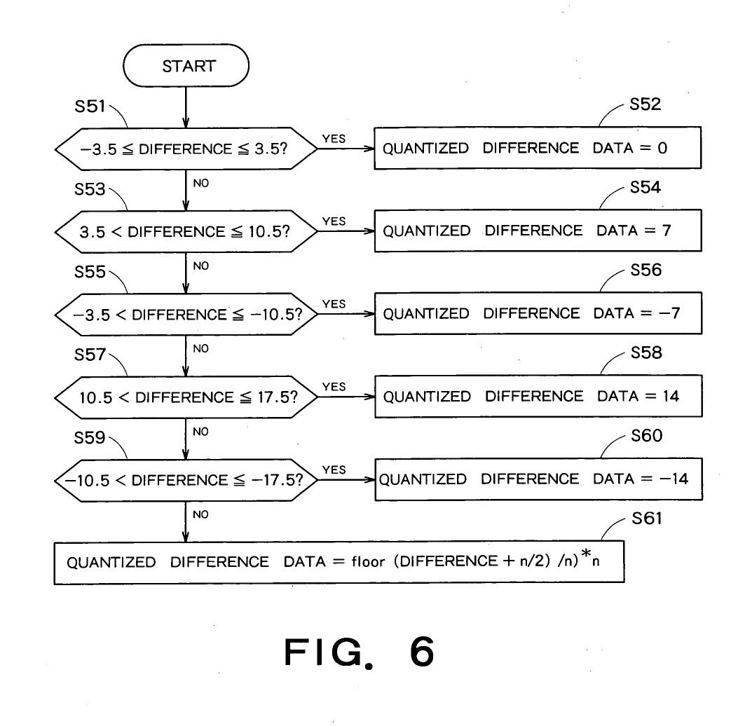

FIG. 6 is a flowchart showing a procedure of the quantizer 12, where a particular quantization characteristic (0714 characteristic) is selected at the step S4 in FIG. 3. First, the step S51 determines whether −3.5≦difference ≦3.5. If YES, select the step S52 “quantized difference data =0”.

If step S51 returns NO, the step S53 determines whether 3.5≦difference ≦10.5. If YES, select the step S54 “quantized difference data =7”. If NO, the step S55 determines whether −10.5≦difference ≦−3.5. If YES, select the step S56 “quantized difference data =−7”.

If the step S55 returns NO, the step S57 determines whether 10.5≦difference ≦17.5. If YES, select the step S58 “quantized difference data =14”. If NO, the step S59 determines whether −17.5≦difference ≦−10.5. If YES, select the step S60 “quantized difference data =−14”.

If the step S59 returns NO, the quantized difference data is given by the step “n”=31 according to the above equation (8) (Step S61).

The processing from FIG. 4 to FIG. 6 may be performed by software or hardware. When the processing is performed by hardware, you may need memory etc. in order to store a conversion table, which gives the correspondence between differences and quantized difference data.

If the difference falls within the range ±3.5, the “0123” characteristic of FIG. 4 includes the quantization step of “1”. The “1” quantization step intends to guarantee fine 8-bits accuracy for flat context by using its quite steep distribution around 0.

The “01312m2” characteristic in FIG. 5 intends to prevent average degradation of an image, considering the case that slope of the distribution becomes rather gentle. The postfix “12m2” denotes its quantization value “12 minus 2”, 12−2=10 instead of 12: the characteristic quantizes a data within the range (from 5 to 19) to the value 10, with the changed range centered on 12.

The “0714” characteristic in FIG. 6 gives a coarse quantization: from −3 to +3 to 0, from −4 to −10 to −7, from +4 to +10 to +7, and so on, where the total number of quantization steps is seven.

There is no intention for the quantizer 12 to restrict the quantization characteristic to those explained in FIG. 4 to FIG. 6. Generally, the wider quantization step is, the smaller data loss is and the more improved image quality is. Therefore, if you request higher quality image, you may adopt alternative quantization characteristic with more quantization steps (finer step) for quantizer 12. On the other hand, if you admit relatively lower image quality, you may adopt another alternative quantization characteristic with fewer quantization steps (that is, wider step) for quantizer 12.

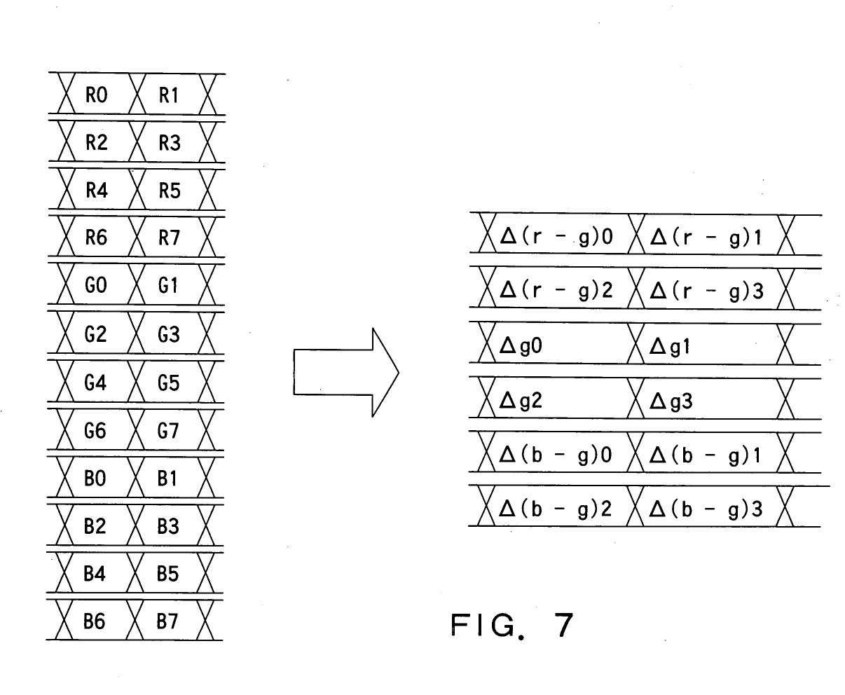

FIG. 7 shows a format of image data, where the image data is sent out from the image transmitting apparatus 1 to the transmission lines 3. FIG. 7 shows merely an instance: another format may be used. In the right format of FIG. 7, the six transmission lines 3 (the half of the conventional twelve illustrated on the left format) transfers the same size of image data as the conventional twelve transmission lines 3. The first difference image generator 11 in the image transmitting apparatus 1 generates difference image data R-G, G, B-G. The difference image data is quantized by the quantizer 12, then coded by the encoder 13 and sent out to the transmission lines 3. The image receiving apparatus 2 receives the code word, performs decoding and inverse quantization, and then reconstruct RGB image.

As the embodiment adopts multi-valuation (4-valuation, here) in encoding, the width of transmission lines 3 is reduced to the half of conventional transmission lines. The described instance here gives the case where eight bits of image data for each of RGB is transmitted in the two cycles by using six transmission lines 3. Transmission method may be modified variously by changing the width of transmission lines 3 or the number of cycles. For instance, full serial transmission may be performed for the transmission line 3 when the number of cycles is increased.

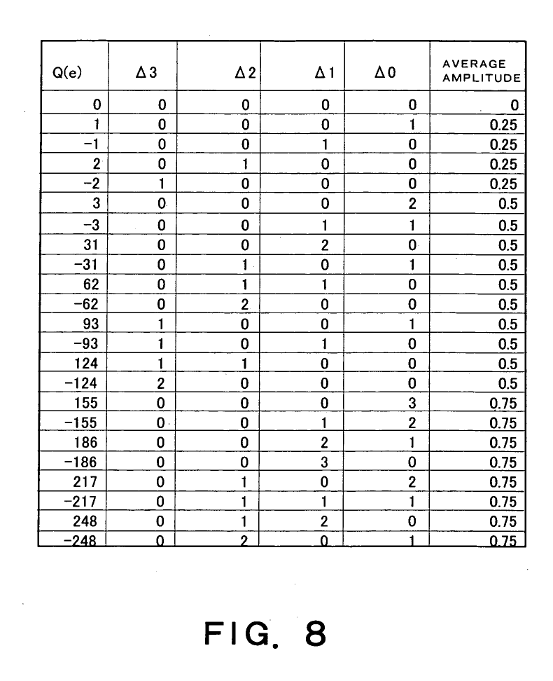

FIG. 8 is a code table corresponding to the encoder 13. In the figure, “Q (e)” is a quantized difference data e to be coded by a code word Δ of four 4-valued digits from Δ0 to Δ3. For instance, for Q (e)=1, data e is encoded as follows: (Δ3Δ2Δ1Δ0)=(0001). In the case of eight-bit image, as predicted and actual image data may widely vary in the range [0, 255] respectively, the difference data falls within the range [−255, 255].

FIG. 8 gives an instance of encoding in the case where the quantizer 12 has the quantization characteristics of FIG. 4. Therefore, as encoding should be performed for each of the quantization characteristics, each characteristic requires its code table as shown in FIG. 8.

The expression (Δ3+Δ2+Δ1+Δ0)/4 gives average amplitude of the code word in each line in the table of FIG. 8. In order to construct the code table, code words are sorted in the ascending order of average amplitude (lower amplitude first): that is, small quantized difference data Q (e) is allocated first in the ascending order of average amplitude.

That is to say, a code word with lower average amplitude is allocated first to a quantized difference data with smaller value. As the quantized difference data Q (e) has the Laplace distribution, which steeply distributes around 0, the above allocation will reduce the average amplitude.

When two code words within the same average amplitude are swapped, there is no affect on the average amplitude of the code word: the average amplitude has the same as before swapping. Therefore, the code words within the same average amplitude in the code table are swappable in any order.

If image data were not lossy (that is, lossless without quantization), the code table would consist of 511 code words in the full range: from −255 to +255. So, this embodiment greatly reduces the full 511 code words to fewer 23 words by the quantization.

Thus, such great reduction of code words enables us not only to downsize a system size of an image transfer system, but also to reduce average amplitude by the quantization. This suggests further reduction of both power consumption and EMI noise.

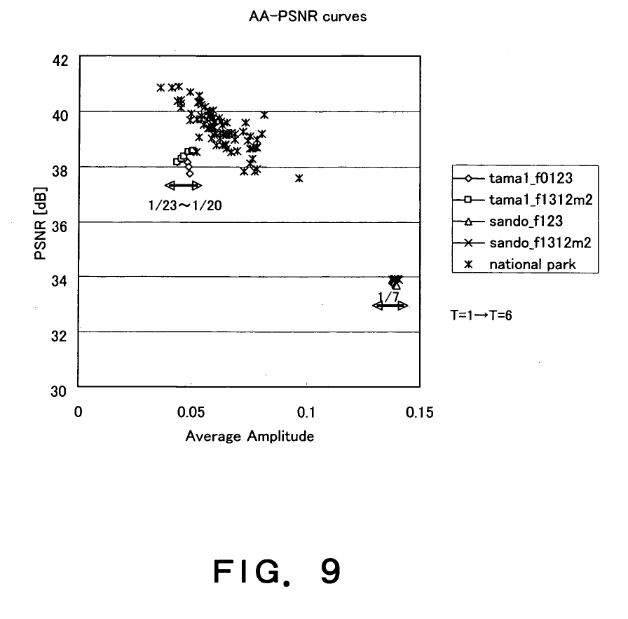

FIG. 9 shows analyzed results for images A to E encoded by the embodiment. In FIG. 9, the abscissa axis indicates average amplitude of each image and the ordinate axis indicates PSNR (Peak Signal to Noise Ratio). The index PSNR is popular in spite of the fact that PSNR cannot reflect all aspect of visual artifacts such as pseudo-contour. Images A to E are analyzed as representatives for DVD MPEG2.

The larger PSNR is, the more similar image is to its original image. As apparent from FIG. 9, PSNRs are distributed roughly 40 dB. PSNRs are obtained roughly 40 dB because that an image of DVD MPEG2 is used as the input image. Note that the usage of MPEG2 image does not mean that the original image of MPEG2 compression is available as our reference image. The correlation enhancement introduced by MPEG2 is a primary reason for obtaining such a high value 40 dB. When analyzing an uncompressed image as an input image, PSNR value is expected to shift down to roughly 20 dB.

FIG. 9 shows the results on the images A, C and E where its quantization is given by the quantization characteristic of FIG. 4, and on the images B and D where its quantization is given by the quantization characteristic of FIG. 5. The threshold T in FIG. 3 is fixed to 3.

The image E is a television image. Image compression by MPEG or the like generally loses image information in a television image: TV image has essentially less information than an image from a digital camera. That is, as correlation of difference data is high, the embodiment gives better performance results.

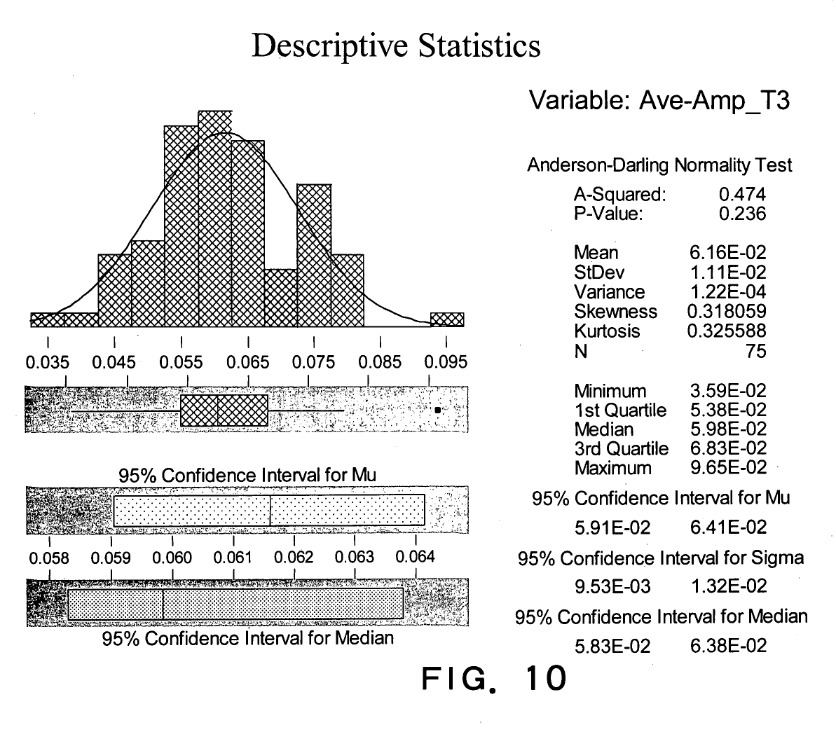

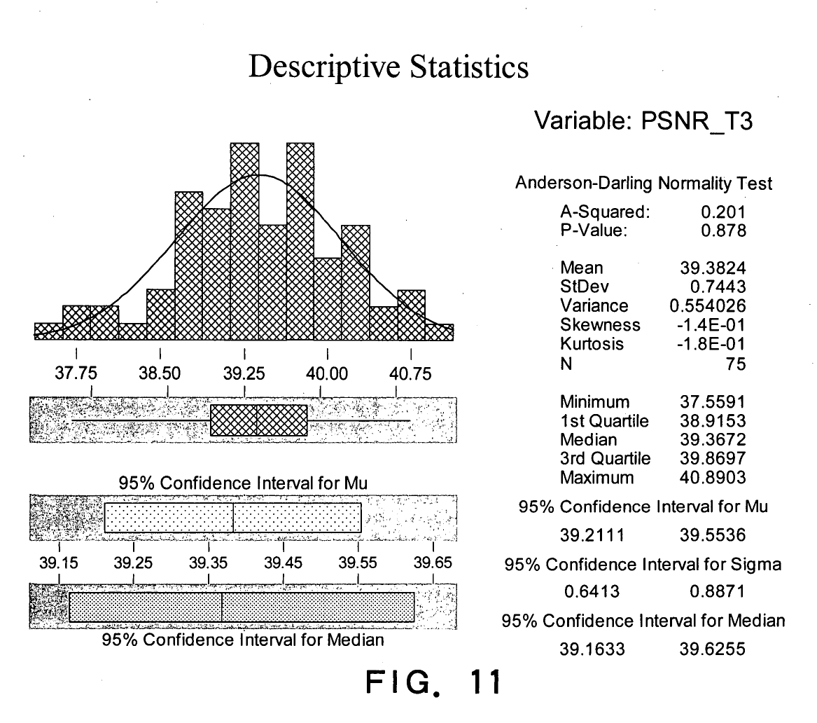

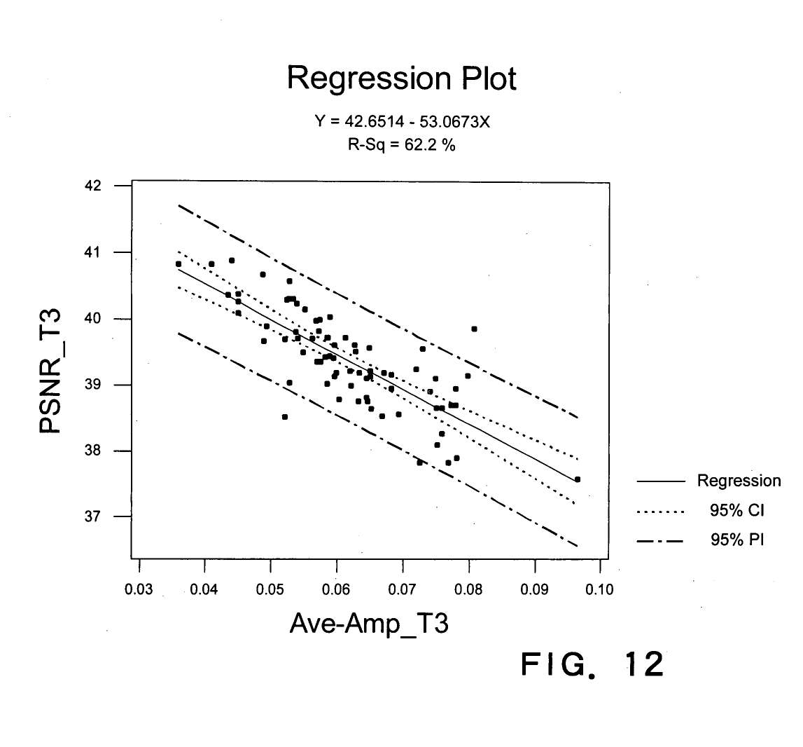

FIG. 10 is a statistic result of average amplitude of the images A to E. FIG. 11 is a statistic result of PSNR for the images A to E. FIG. 12 is a regression analysis on average amplitude and PSNR for the images A to E.

As reading from the figures, the average amplitude is about 0.062 (nearly 1/16), an average PSNR=39.3 dB: this means “near lossless”. Generally, 40 dB is a popular reference for near lossless. In our results, the PSNR is somewhat lower to 40 dB. However, even when the PSNR is rather lower than 40 dB, this small shortage does not cause significant visual deterioration. That is, the value 40 dB is just a reference, but is not absolute “must” reference.

As reading from FIG. 9, the TV image “E” has a relatively high PSNR. Therefore, for a TV image in general, average amplitude can be reduced, where degradation of image is simultaneously reduced. As “average amplitude” as a measure is almost in proportion to EMI noise, reduction of the EMI noise is also expected to roughly 1/16.

In summary, as described above, according to the first embodiment, average amplitude of data transmission has been reduced, this means that power consumption and EMI noise also has been reduced and width of transmission lines 3 also has been reduced. This is because the coding is performed after enhancing the correlation: the difference image data is quantized in considering surrounding pixels.

### Second Embodiment

The second embodiment will furthermore reduce level of multi-valuation for code word than the first embodiment.

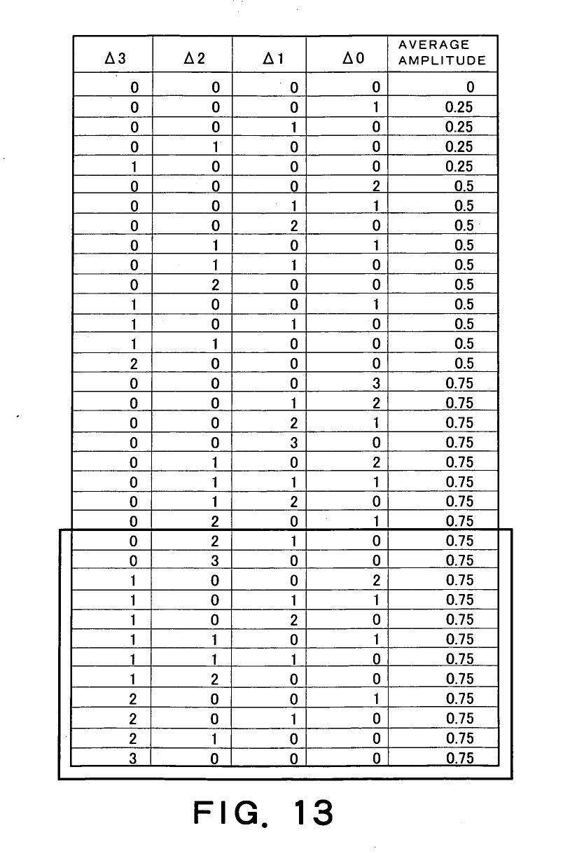

FIG. 13 is an instance of code table. In FIG. 13, the box with bold border marks the code words with average amplitude 0.75. The embodiment will try to remove the code word whose average amplitude is 0.75. In FIG. 13, code words with average amplitude 0.75 are twelve in total count. It includes two 4-valued code words (with coded by using a digit “3”). When average amplitude is same for two code words, a desirable choice is a code word consisting with smaller digits, in order to reduce level of multi-valuation. Therefore, in the embodiment, the 4-valued code words are to be removed. For this removal, although the code word has still larger average amplitude but very less occurrence frequency, thus such partial removal gives no significant affect for image quality as a result.

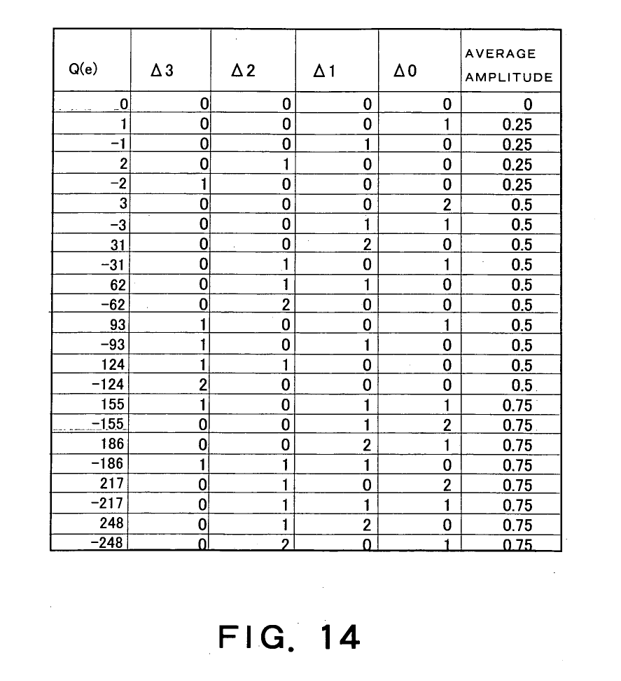

FIG. 14 is a modified code table of FIG. 13, where 4-valued code word has been completely removed. If coding is performed according to this code table, data transmission will be modified to performed with 3-valuation (from 0 to 2) instead of 4-valuation (from 0 to 3). Thus the size of a circuit in the image transfer system is reduced.

Hereinafter, the code word generated in the above procedure will be called “qOAC3h”, where the term “qOAC” denotes Quantized Ordered Amplitude Code, and the infix “3” denotes the level 3 of valuation, and the postfix “h” denotes to halve the width of lines.

The above has just described an instance of modification of code word from 4-valuation to 3-valuation. Level of multi-valuation of the code word is not limited to 4-valuation or 3-valuation. You are generally admitted to use code word consisting of multi-valued data of “n” level (where “n” is an integer).

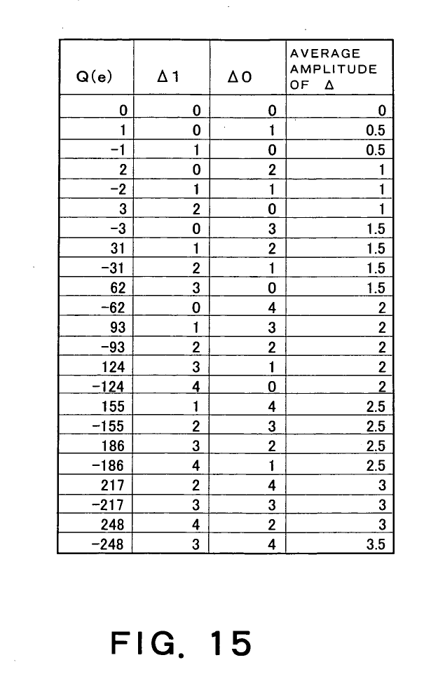

FIG. 15 is an instance of code table, having code words with two 5-valued code digits Δ1Δ0. The code word of FIG. 15 is designed to reduce the width of lines to ½ compared to the code word of FIG. 13, and to ¼ compared to the transmitting at the left side of FIG. 7. Hereinafter, the coding of FIG. 15 will be called “qOAC5q”, where the postfix “q” denotes quarter.

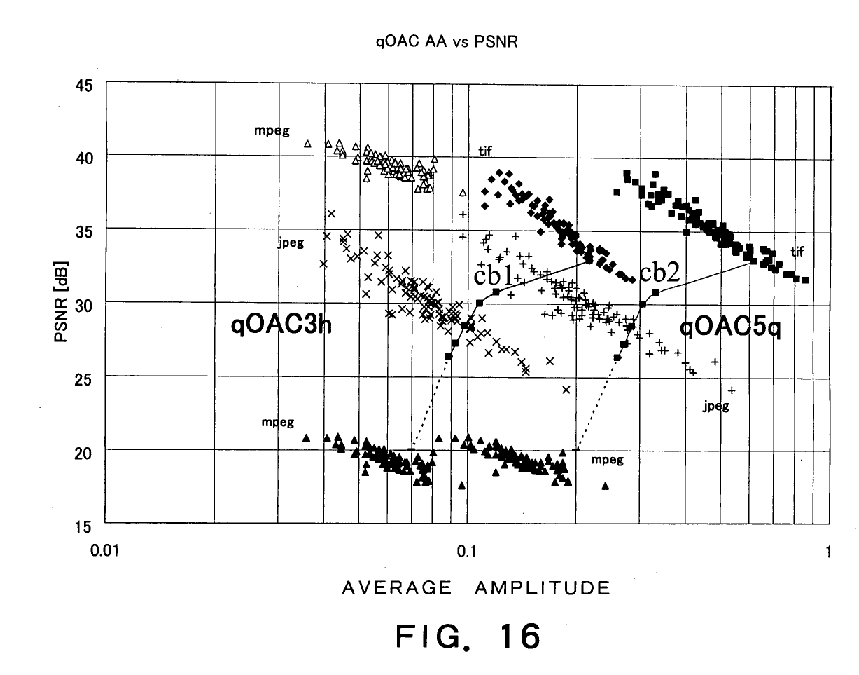

FIG. 16 shows correlations between average amplitude and PSNR for the two coding: “qOAC3h” and “qOAC5h”. It is analyzed results of images: TIF image (not compressed), JPEG image (compressed) and MPEG image (compressed).

The average amplitude of code word in FIG. 14 is statistically similar to the average amplitude of code word shown in FIG. 8, because both code words are sorted similarly in the ascending order. That is, the average amplitude of MPEG images takes a value roughly 0.062 (nearly 1/16).

FIG. 16 contains curves “cb1” and “cb2” indicating two tracing curves between average amplitude and PSNR by controlling compression ratio on a certain JPEG image. Estimated from the tendency of the curves, the PSNR value has been shifted by −20 dB for the MPEG image: the dotted lines (which are connected to “cb1” and “cb2”) indicate the shifted value. This seems unnatural, but only possible remedy, which will be explained below.

As an original image before compression (to be compressed as input) is available for JPEG image, the curves are calculated based in the natural way: an original image is used as reference. Next, consider a TV image of DVD, already processed as MPEG image. In this case, its original image is not available for us. Therefore, for the original image of MPEG, the only possible remedy for us is the estimation from the tendency of curves. Such an estimated ensemble of original image for MPEG is given by the collectives of gray triangle labeled as “mpeg” in FIG. 16 (in the left uppermost), where the data is identical to the FIG. 9.

The coding “qOAC5q” requires only half width of transmission lines 3 compared to “qOAC3h”. On the other hands, its average amplitude doubles from 1/16 to ⅛. Such a result is found also in the other images such as a JPEG image or a TIF image. The coding “qOAC3h” has results: its average amplitude is roughly ⅕ for TIF, and roughly 1/10 for JPEG. The coding “qOAC5q” has results: its average amplitude is roughly ½ for TIF, and roughly ⅕0 for JPEG.

Generally, an artificial image generated by software on a PC has quite high correlation compared to a natural image. So, a simple 1V or 1H correlation may be enough to reduce the average amplitude to the lower amplitude (from 1/10 to 1/100 or less) without using the inventor's scheme. Therefore, the following analysis will focus on a natural image. A PC screen image may include a natural image. A natural image maybe is expanded in full PC screen image (rarely), and a part of a PC screen image may include a natural image compressed by JPEG etc. Therefore, the analysis result of a TIF image can be generally interpreted as a result for distribution targeted on uncompressed application. On the other hand, a JPEG or an MPEG image is generally interpreted as more popular situation. Therefore, when the coding “qOAC3h” is adopted for the JPEG considered as average situation, its average amplitude is expected to be improved roughly 1/10.

In summary, as the second embodiment has removed the code words with a digit of larger amplitude than a specified level among code words of the same average amplitude, the level of multi-valuation and the total number of code words has been reduced, and therefore system configuration has been simplified.

### Third Embodiment

The third embodiment will treat both transition count and average amplitude when sorting code words in a code table.

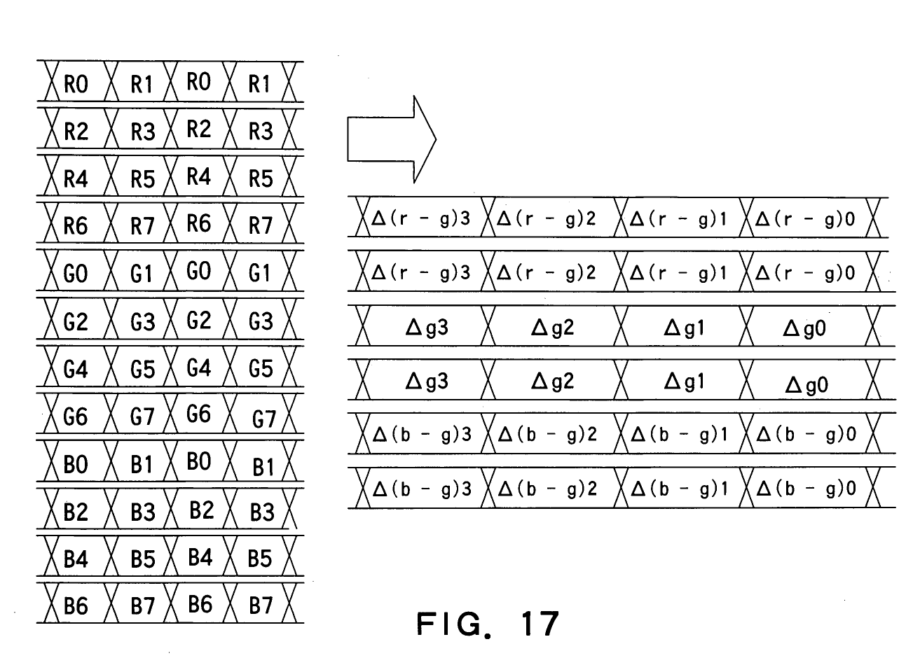

As the embodiment will serially transfer code word Δ3Δ2Δ1Δ0, here, its order becomes meaningful. FIG. 17 is a timing diagram of the data transfer within four cycles. In the case of FIG. 17, image data for two pixels is transferred within four cycles. As shown, image data for R-G, G, and B-G are serially transmitted within four cycles in the similar format, respectively.

In the case adopting a transfer such as shown in FIG. 17, smaller transition count is preferable for the improvement: the smaller transition count of data becomes, the less power consumption becomes, and the less EMI noise.

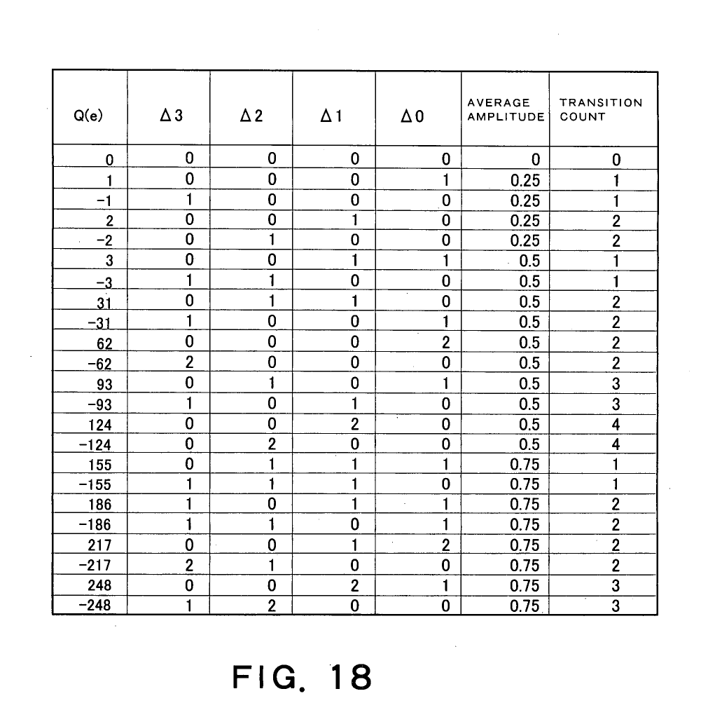

FIG. 18 is a modified code table of FIG. 8 where a new column is added to show transition counts of code word. In FIG. 18, sort the code words with average amplitude in the first priority, and simultaneously sort them with transition count in the second priority. As this sorting forces the coding to simultaneously treat average amplitude and transition count, its optimization has been performed for both average amplitude and transition count.

The supplemental explanation will be given: The quantized difference data with smaller transition count are allocated first to code word with lower average amplitude. This procedure minimizes the transition count of data in order to reduce power consumption and also to reduce the EMI noise, when data transmission performed in the order shown in FIG. 17. Although average amplitude is treated in the first priority in FIG. 18 here, you may have another choice: transition count in the first priority.

In summary, as described above, the third embodiment has illustrated the coding by considering the optimization on both average amplitude and transition count. Therefore, it performs data transmission with lower average amplitude and smaller transition count. This also means the reduction of both power consumption and EMI noise.

### Fourth Embodiment

The fourth embodiment will illustrate a coding by considering only transition count without average amplitude.

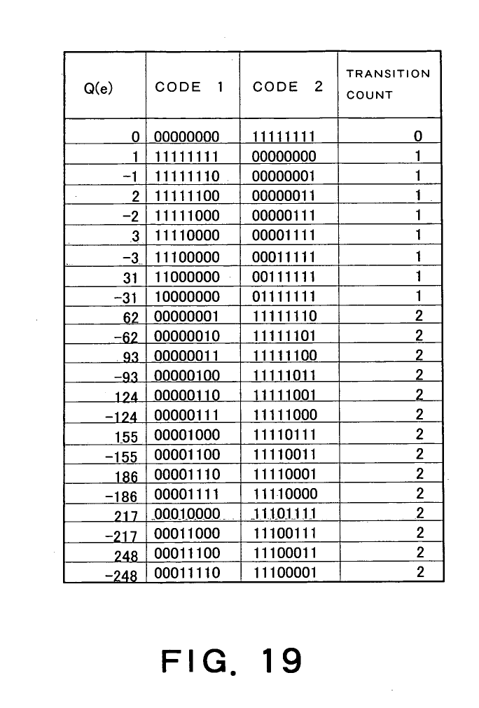

FIG. 19 is an encoding table to minimize the transition count. The column “Code 1” gives code words when the last transferred code word ended in 0, and the column “Code 2” gives code words when the last transferred code word ended in 1. In the both cases, code words are sorted in the ascending order by transition count (with smaller count first).

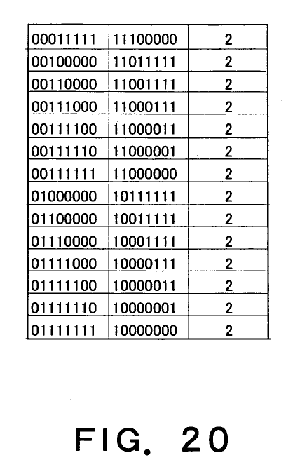

The code table in FIG. 19 does not include all possible code word. FIG. 20 shows a list of code words not used in the code table in FIG. 19.

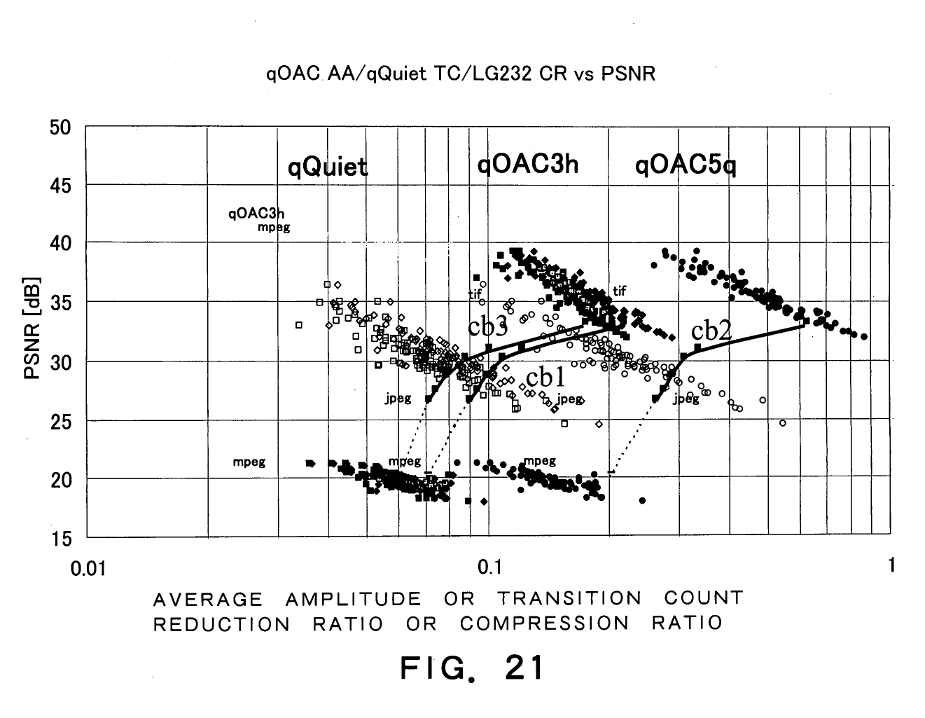

FIG. 21 shows analyzed results with adding “qQuiet” of FIG. 19 to FIG. 16. For “qQuiet”, the abscissa axis denotes transition count. By comparing with FIG. 16, the curve “cb3” of “qQuiet” is slightly shifted to the left from the curve “cb1” of “qOAC3h”. The values are almost similar: average amplitude is roughly 1/17 for MPEG, roughly 1/13 for JPEG and roughly ⅕ for TIF.

In summary, as described above, the fourth embodiment has illustrated the coding by considering transition count without average amplitude. Therefore, data transmission is performed with reducing more transition count.

In the above, FIG. 19 has described an instance of generating 8-bit coded data. You may have another choice: 7-bit coded data with permitting larger average transition count. In this case you may modify a cycle time of clock to transfer coded data, otherwise you may devote a cycle of the deleted single bit to controlling signal of transfer. As this embodiment has removed code words (with its count from 511 to 23), such alternative has been obtained to allocate the cycle of deleted bits to the other signal bits such as controlling signals of transfer.

### Fifth Embodiment

The fifth embodiment will not only reduce transition count but also improves an S/N ratio in image data transmission.

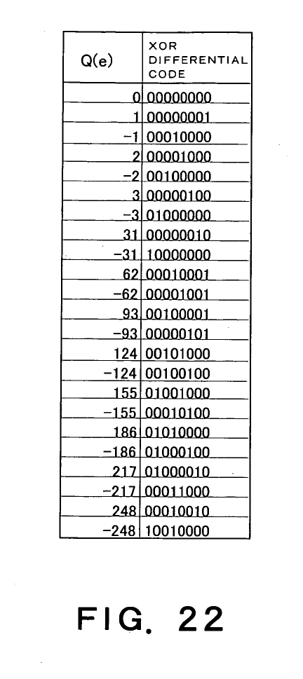

FIG. 22 is a code table according to the fifth embodiment. FIG. 23 is an outlined configuration of image transfer system according to the fifth embodiment. In FIG. 23, the common components to FIG. 1 are indexed by the identical reference. The following will mainly focus on the difference from FIG. 1. The image transmitting apparatus 1 in FIG. 23 has modulo part (Σmod2) 17. This modulo part calculates a remainder: divide the coded data output from the encoder 13 by an integer “two”. Data output from this modulo part 17 is sent to the transmission line 3. The image receiving apparatus 2 has the difference detecting part 26. The part 26 calculates XOR of adjacent bits for the data sent from the image transmitting apparatus 1. Except the explained in above, the image transmitting apparatus 1 of FIG. 23 has similar configuration to that of the image transmitting apparatus 1 of FIG. 1. The image receiving apparatus 2 of FIG. 23 has similar configuration to that of the image receiving apparatus 2 of FIG. 1.

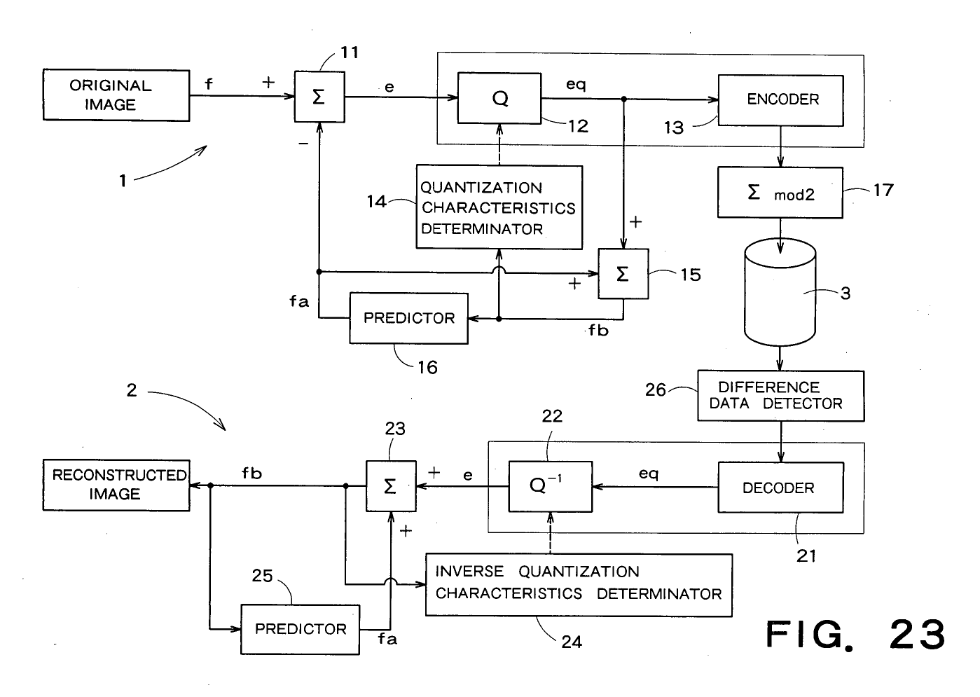

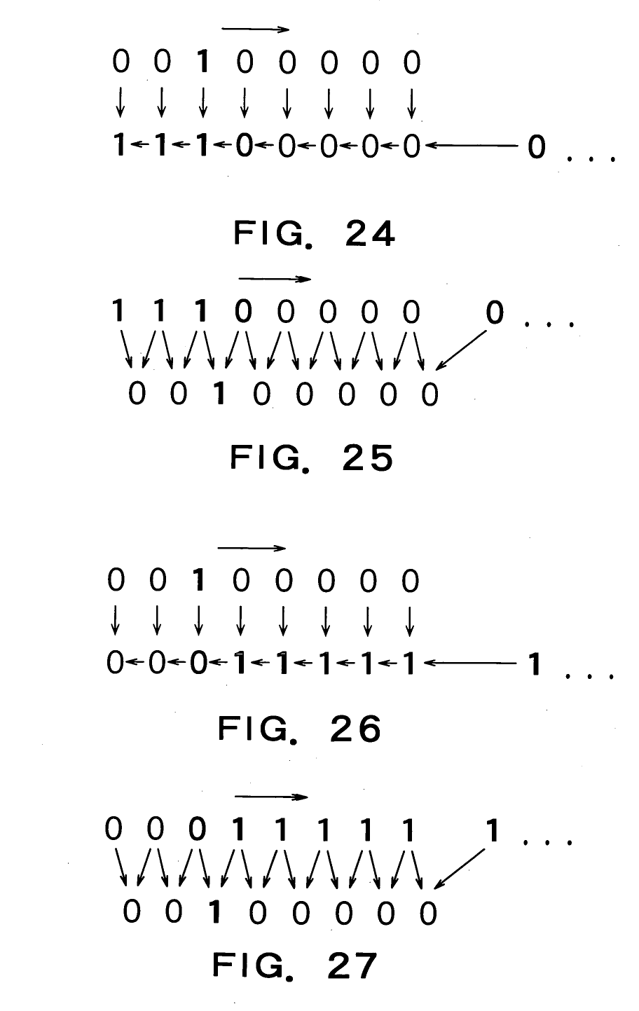

The processing of the embodiment will be described by an exemplification for a quantized difference data Q(e)=−2. First, the quantized difference data Q(e)=−2 is converted into 00100000 according to the code table of FIG. 22. FIG. 24 illustrates a processing of the modulo part 17 in the case that a previous encoded data ended in 0. FIG. 25 illustrates a processing of the difference detecting part 26 that receives a data generated by FIG. 24. FIG. 26 illustrates a processing of the modulo part 17 in the case that a previous encoded data ended in 1. FIG. 27 illustrates a processing of the difference detecting part 26 that receives a data generated by FIG. 26.

In FIG. 24, the following two “0” are added at first, its result is 0+0=0: the bit “0” of LSB in the code word 00100000 corresponding to quantized difference data Q(e)=−2 and a previous last data “0” (shown as rightmost “0” fed to the code word). Next, the result “0” is added to the lower second bit of the code word: a second result is 0+0=0. Repeat the same process thereafter.

The lower sixth bit of the code word is “1”, and its modulo data is 0+0+0+0+0+0+1=1. As the next is lower seventh bit “0”, its modulo data is (0+0+0+0+0+0+1)+0=1. “0” is found at the lowest eighth bit (namely most significant bit: MSB), and finally (0+0+0+0+0+0+1+0)+0=1. Therefore, the sequence of 00000111 (its left-to-right order is reversed against the right-to-left order in the FIG. 24) has been finally generated as modulo data.

The data sequence generated in FIG. 24 is transferred in the order of right bit first. Therefore, data bits of 0s from the first to the fifth and data bits of 1s from the sixth to the eighth are transmitted in sequence. The bit at root of arrow is processed first: the head bit of arrow is processed next.

A sequence is calculated in the same manner in FIG. 26, however, its result is a bit inverted result of FIG. 24, because the data bit “1” comes at first. That is, data bits of 1s from the first to the fifth and data bits of 0s from the sixth to the eighth are transmitted in sequence.

Next, a processing will be described for the receiving side. FIG. 25 is the case that the first data is 0, and FIG. 27 is the case that the first data is 1. At first, FIG. 25 will be described. In FIG. 25, a data is given as the sequence 11100000 (the order is from left to right). The data is decoded by taking XOR of two adjacent bits. In the case where the rightmost 0 comes at first, the calculated result is 0: the 0 is XORed with the first 0. Calculation continues to be processed in the same manner thereafter, and the sixth calculation is 0XOR1=1: the input fifth bit and the sixth bit are XORed. In the seventh calculation, the input sixth bit and the seventh bit are XORed and its result is 0. In this manner, processing advances in sequence. XOR is inverse operation to Σ, so it decodes coded data to its original bit sequence.

In the embodiment, 3 dB SNR gain is obtained at discrimination point by transmitting a difference (XOR) between two adjacent bits. The 3 dB gain comes from the fact: as information transfer spans over two cycles, its Hamming distance is 2, where 2 giving 10*log10 (2)=3 dB. It's meaning will be further explained from the additional interpretation of circuit variations as below.

Two levels “0” and “1” are discriminated by their center value 0.5. It is difficult to guarantee variation accuracy in absolute value of the center value given as the physical quantity (voltage, current) in circuit. It is also difficult to reduce size of circuit for the same purpose. On the other hand, when compared in relative value as logical difference (XOR-ed) data, absolute value of level needs not to be detected. This means variation accuracy is more easily guaranteed.

In this way, such gain at discrimination point improves circuit tolerance against fluctuation. XOR operation of FIG. 25 is interpreted as channel coding technology: the technology determines a code on channel using analog circuit, instead of using logic circuit (0 and 1).

The embodiment is characterized by the processing that the same data as given in FIG. 22 is transferred, and simultaneously the SNR at the discrimination point is improved. In this improvement, there is no affect for the reduction of transition count.

Such a differential processing will be also applied to not only the modulus 2 system but also the modulus 3 system. For modulus 3, Σ is re-interpreted in mod3 and differential detection also is re-interpreted in mod3. In this re-interpretation procedure, such differential detection is applicable also to the third embodiment, because the re-interpreted data is serially transferred in the third embodiment of FIG. 17.

Generally it is foreseeable to use modulo “n”, where n is an integer. Roughly speaking, the embodiment can be considered as an instance of group codes. This will give a larger effect (larger reduction of average transition count) especially when quantized. In addition, such differential can be applied for lossless coding, and 3-dB gain will be obtained. The code of FIG. 22 can obtain the same performance effect as that of FIG. 21.

In summary, as explained above, in the fifth embodiment, logical-differential (XOR) processing not only has reduced the transition count but also has improved the S/N ratio at discrimination point.

### Sixth Embodiment

The sixth embodiment will adopt Golomb coding for our coding.

The Golomb code is a well-known variable length code. In order to compress image data, the code words with short length are allocated first for data. Generally in the past, only code length was used as an index of performance. Here repeated again, the present invention is characterized by the multiple performance indices: the performance improvement is archived by not only code length but also transition count and signal amplitude.

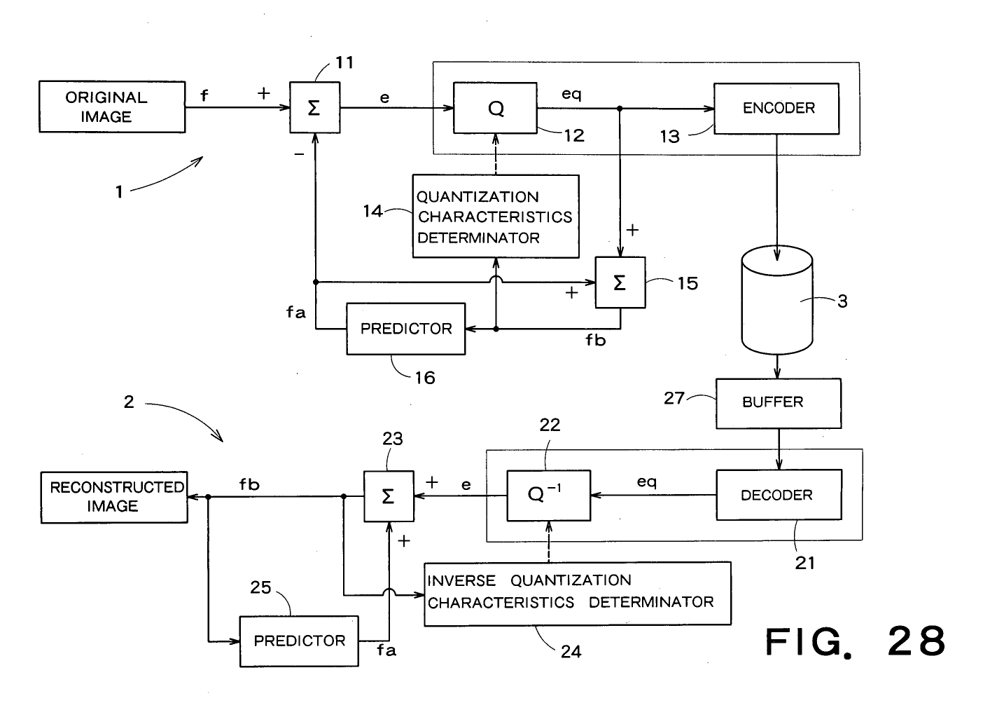

FIG. 28 is an outlined configuration of the image transfer system according to the sixth embodiment of the present invention. The image transfer system in FIG. 28 has a configuration having a buffer 27 in addition to the configuration of FIG. 1. The buffer 27 is required in order to extract data where data have different length.

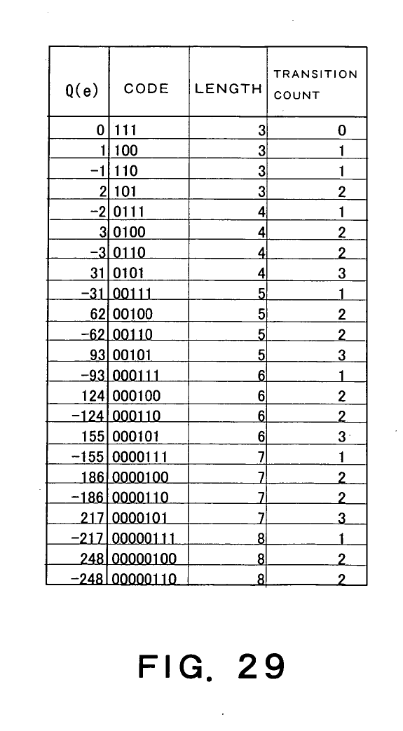

FIG. 29 is a code table of the embodiment. FIG. 29 is characterized by the processing that its sorting is performed on the Golomb code by considering both code length and transition count. As shown in FIG. 29, for Golomb code words with the same length, code words with smaller transition count are preferably allocated (smaller transition count first): that is, sort the codes with the same length in the ascending order of transition count.

For instance, as the code words with length 3, there are four code words: 100, 101 100, 111. Among these four code words, “111” has the smallest transition count. Therefore, the code word “111” will be allocated to data “0”. The code words “100” and “110” have the second smallest transition count. So, “100” will be allocated to “+1” and “100” will be allocated to “−1”. As the remaining “101” has the largest transition count, it will be allocated to “+2”.

Thereafter, as in the same manner, the code words with the same length will be allocated in the ascending order of transition count.

This allocation strategy reduces average transition count without degrading performance of average code length. Hereinafter, abbreviate the term Transition Ordered LG (2, 32) to TOLG (2, 32), where the prefix “TO” denotes the ordering by transition count.

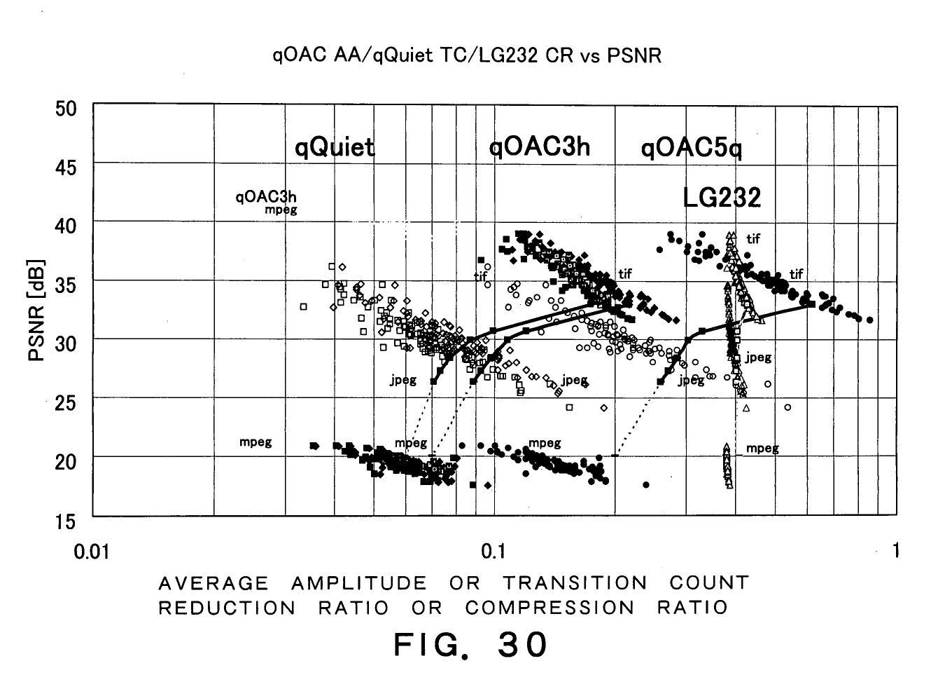

FIG. 30 is an analyzed result by the embodiment. For image of TIF, JPEG and MPEG, there is no significant difference on their performances: performance values vary mainly in the range between 0.4 and 0.5, that is, roughly speaking “½ or less”. It is possible to lower its operating frequency of data transmission by ½. As EMI noise is in proportion to square of frequency, its EMI noise can be reduced by ¼. Therefore, the embodiment has the effect to reduce EMI noise.

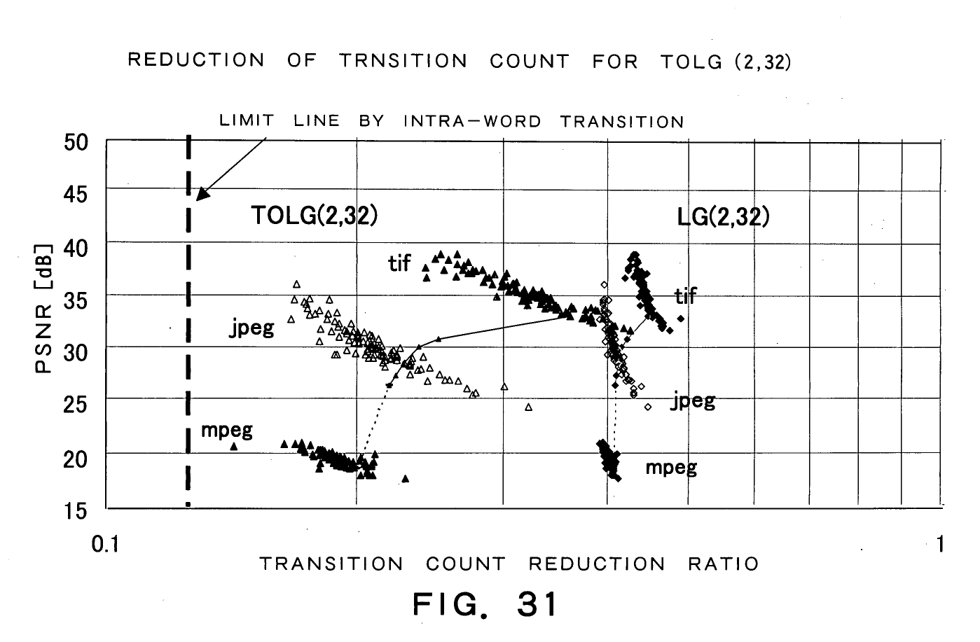

FIG. 31 is another analysis. Transition counts are improved respectively: from 0.4 to 0.2 for MPEG, from 0.4 to 0.2 for JPEG, and 0.45 to 0.3 for TIF. The final synergistic EMI noise reduction performance is expected to reach to 1/20 for MPEG by multiplying the two performances: (1) the performance ¼ given by the above-mentioned data compression and (2) the performance 0.2=⅕ given by the coding TOLG(2,32). Similarly, it is expected to reach to 1/18 for JPEG, and 1/9 for TIF. In summary, its performance has been expected to be 1/10 in general, and 1/20 at maximum for TV images of MPEG.

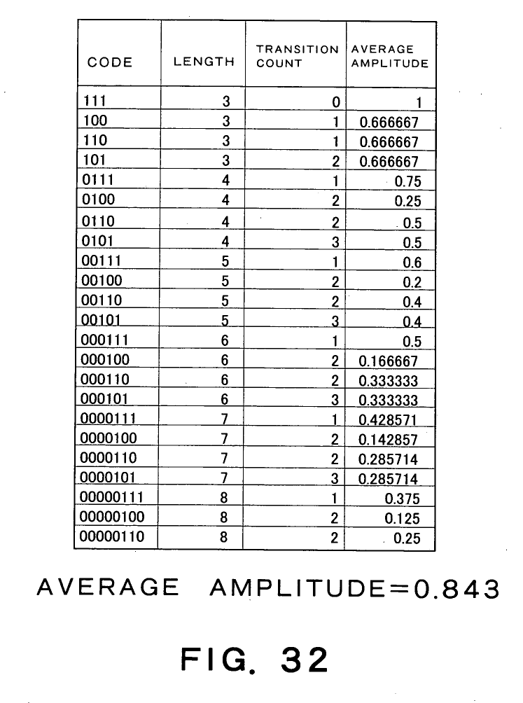

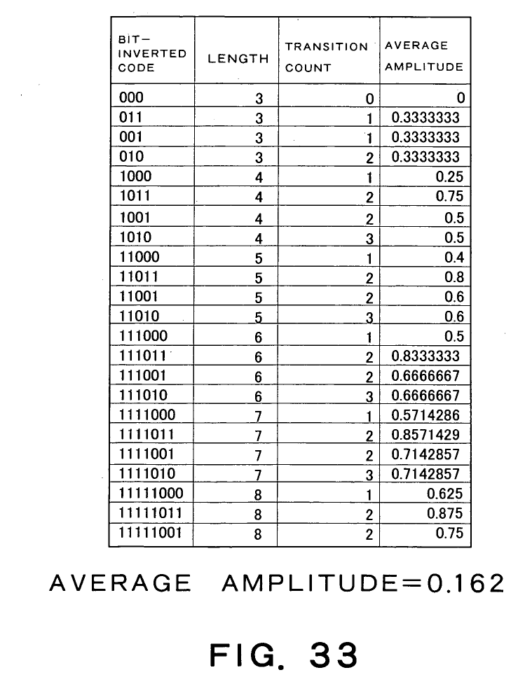

FIG. 32 is an instance of a code table where average amplitude is added as a new performance index. In FIG. 32, the average amplitude is 0.843 for a certain image. FIG. 33 is a modified code table where its average amplitude is further improved to 0.162. The code table of FIG. 33 is generated by the bit-inversion of the code words given in FIG. 32.

As the bit-inversion does not update both its code word length and its transition count, the embodiment is characterized in the fact that the bit-inversion will improve the performance of average amplitude while keeping the previous two performances. The coding “invTOLG(2, 32)” denotes the coding obtained by the bit inversion of the coded words of TOLG(2, 32). For instance, the prefix of 000 . . . 1 in the original Golomb code is converted to the prefix of 111 . . . 0 by the bit-inversion.

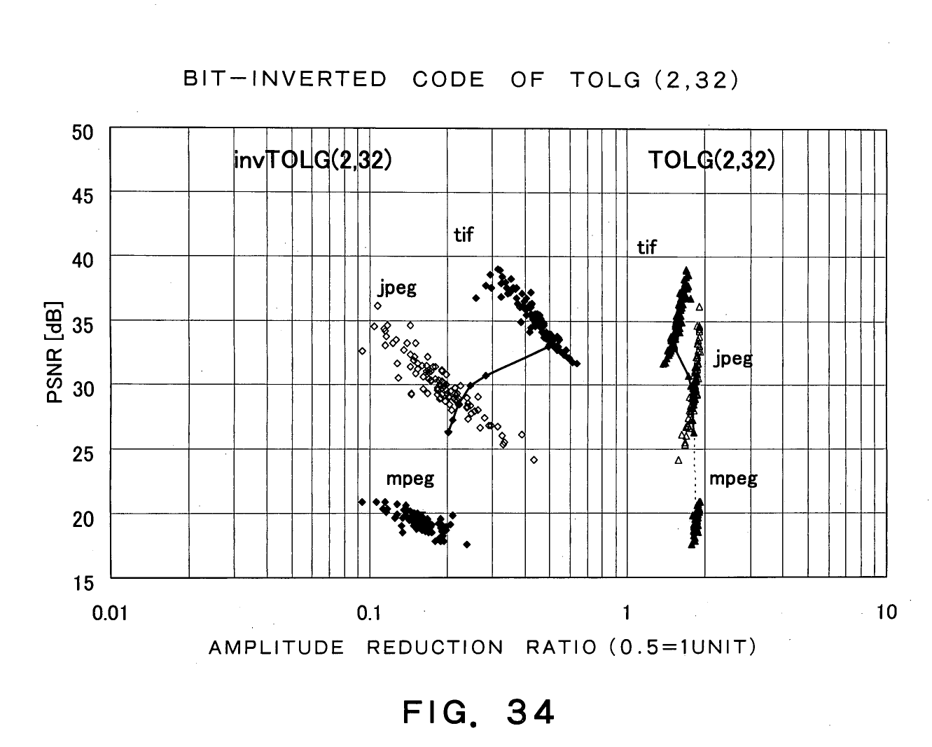

Comparing FIG. 32 and FIG. 33, the code table of FIG. 33 has more frequent occurrence of “1”. Actually, the occurrence probability of Q(e)=0 is quite high, and the code word “000” has great contribution to its performance. Therefore, the coding invTOLG(2,32) given by FIG. 33 has lower average amplitude than the coding TOLG(2,32) given by FIG. 32: FIG. 34 reconfirms such comparison.

In summary, as described above, the sixth embodiment has exploited the Golomb code with considering simultaneously average transition count and average amplitude. This also implies that power consumption and EMI noise has been reduced.

Above described the application of the Golomb code as a variable length code. The other well-known compression coding is also applicable for our purpose: such as the arithmetic coding, and the Huffman coding. The LG (2, 32) is merely an instance of Golomb code for our explanation, a shape (distribution) of the Golomb code should be preferably best-matched to the shape of quantized difference of actual data: so you should not limit coding to the LG (2, 32). This discussion holds true for other coding such as the arithmetic coding or the Huffman coding (in further, including multi-valued Huffman coding). Quantization of data has great impact on performance. Moreover, the same discussion holds also for lossless coding, even where quantization is not performed.

### Seventh Embodiment

The seventh embodiment will exploit a C1 prefix code. The C1 prefix code is classified as a certain kind of variable length code for compression. Here, the embodiment uses the C1 coding depending on a context as well as using the similar ordering technique to reduce transition count. The seventh embodiment will enhance the capability to reduce inter-word transition count, which is the same idea as already adopted in “Quiet coding”.

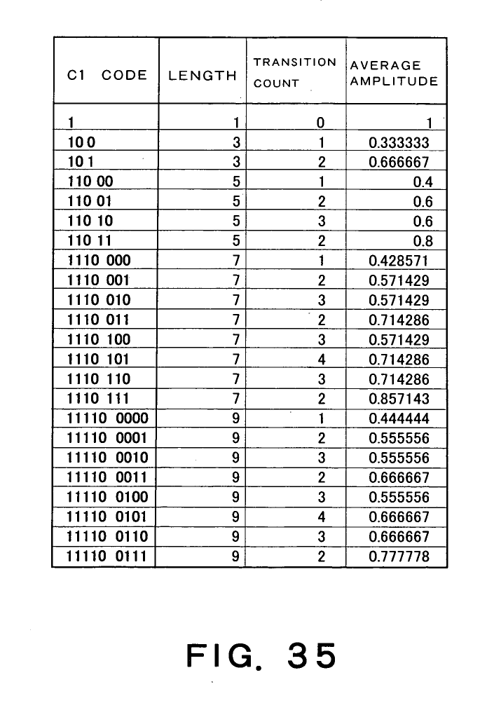

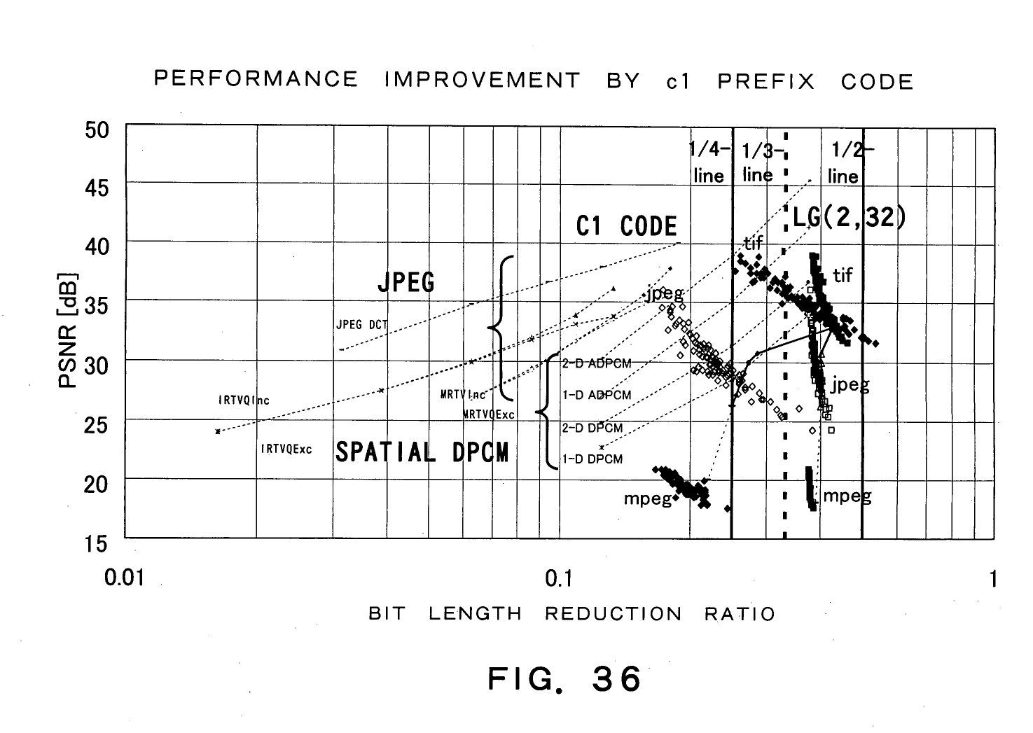

FIG. 35 is an instance of a code table where the C1 prefix codes are used. FIG. 36 is an analyzed result in the case data is transferred by using the code table in FIG. 35. The abscissa is data compression ratio by logarithms. The ordinate is PSNR. FIG. 35 additionally includes the results of LG (2, 32) in FIG. 30 and FIG. 31 for the sake of comparison.

In FIG. 36, 1D-DPCM, 2D-DPCM, 1D-ADPCM, 2D-ADPCM are results for spatial DPCM. MRTVQ, IRTVQ (Include, Exclude) are compressed results for JPEG. These use DCT, (that is, these perform signal processing in frequency domain), and thus the performance is improved further, but the cost for hardware realization is quite large.

The compression performance of the C1 prefix code is more sensitive to image itself than LG (2, 32). It is roughly 0.4 for the LG (2, 32) but it varies from 0.2 to 0.5 for the C1. This is because that (1) the length “1” of the C1 code allocated to 0 is small enough and (2) reduction capability of size for the C1 is more sensitive to the entropy of image itself. It is possible to achieve ¼, when application is especially focused on TV, that is, in the case that image is limited to MPEG. For this application, the seventh embodiment of the C1 is preferable than the previous embodiment of the LG (2, 32). Viewing from the EMI noise, not only data compression, but also transition count has been reduced. Further improvement will be performed as follows.

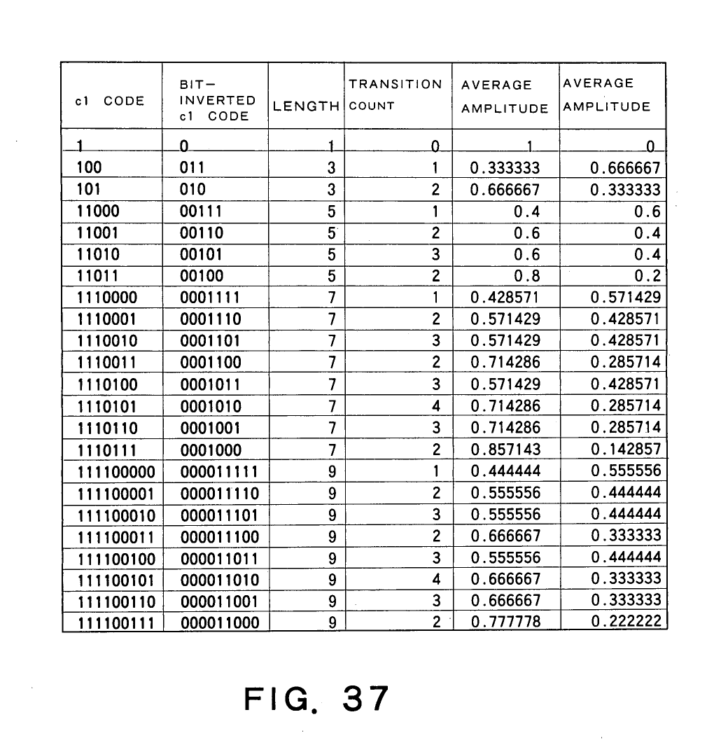

FIG. 37 is a modified code table, which improves the code table of FIG. 35. A pair of C1 code and its bit-inverted C1 code is allocated to a single value. The first bit of C1 code is always “1”. Similarly, the first bit of bit inverted C1 code is always “0”. The coding selection (either C1 or the bit inverted C1) is intentionally designed to select code based on the last bit of previously transferred data: the last bit of the previous data is forced to be always identical to the first bit of the current data.

The purpose of the coding selection is elimination of transition between two code words (called an inter-word transition). If eliminated inter-word transition, you need only to calculate the sum of probability based on the transition count (of the intra-word transition) given by FIG. 37. If there is inter-word transition, the transition count should be added to the result. In FIG. 37, the pair of code is allocated with alternating plus and minus sign starting from the center “0”. The inverted pair means that its bit of paired code is always inverted to the bit of the paired other code. Therefore, the probability to have a value “0” for the last bit is the same as the probability to have a value “1”. As probability having a data value “0” is statistically 0.5 in general, occurrence probability having a value other “1” is 1−0.5=0.5. Therefore, 0.5/2=0.25 is the estimation for the average transition count including inter-word transition.

An 8-bits data has 4 transitions per code word when no coding. So, a relative compression ratio is given by a value divided further by 4.

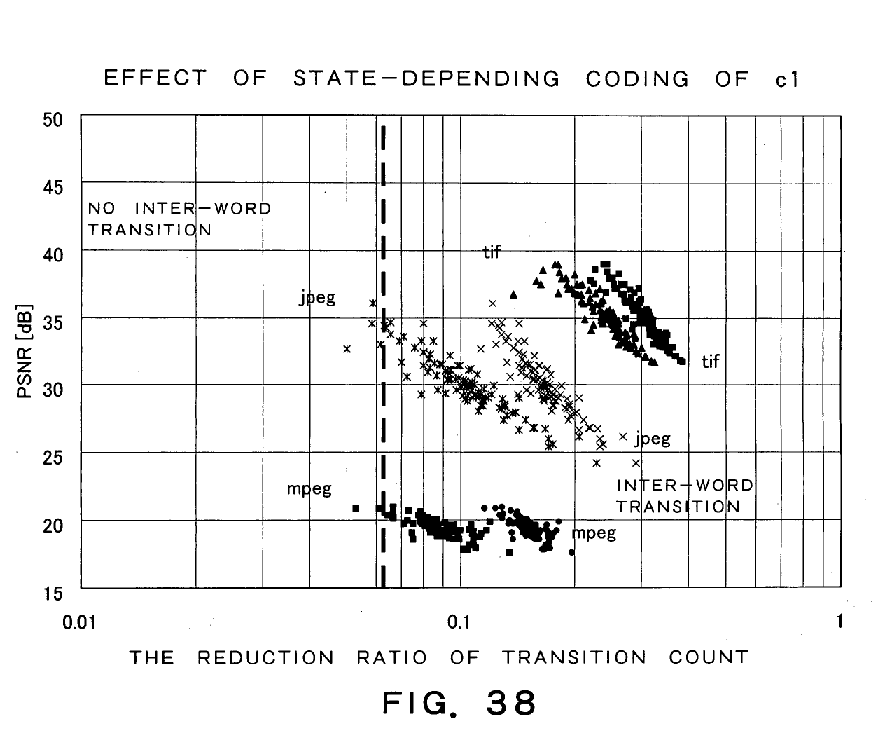

FIG. 38 shows results calculated in this manner. The paired C1 code reduces transition count by roughly 30 percent (1 to 0.7). The C1 code reduces the transition count to roughly ⅕. As a result, MPEG has performance of reducing transition count to roughly 1/10. Therefore, if you wish to measure final synergistic performance by multiplying this performance with the performance for previous data compression ¼ (¼ in frequency), the final performance becomes larger 1/16* 1/10= 1/160. If you give high priority on the width of wiring lines, another option will be given as follows: ½ capability is used to reduce width of lines and the remaining ½ capability is used to lower operating frequency. In this case, EMI noise reduction is ¼* 1/10= 1/40, and width of lines is reduced to ½. This result exceeds the performance 1/20 described in the first (FIG. 1A to FIG. 1C), and simultaneously reduces width of lines to ½.

In the above discussions, information source has been encoded by prediction difference based on the DPCM framework. As its technological essence is the exploitation of the deviation in distribution, you don't need to restrict yourself only to the DPCM technology. The prediction difference exploited above is spatial in DPCM. For instance, the distribution of power spectrum in DCT of MPEG2 that deals data in frequency domain is also known to be Laplace distribution. So, it is similarly exploitable. That is, the coding that disclosed in the present invention has been naturally used by considering average transition count as channel code: such as Golomb codes or arithmetic codes with respect to a frequency domain data of DCT. For instance, as deviation of probability distribution is also essentially inherited in MPEG data which is channel coded by QAM, it is foreseeable that power consumption will be reduced so that the EMI noise simultaneously is reduced when QAM codes are also sorted in signal amplitude. Here, for instance, consider the sort of following quantities: not only average amplitude (a distance from an origin on I and Q axis plane) but also quantity of change corresponding to transition count (displacement distance on the plane of I and Q axis) due to transitions. The less change of data is, the less physical change occurred in circuits: thus, lower power consumption and lower EMI noise is expected too. Such discussion holds true for the previous sixth embodiment.

In summary, as described above, the seventh embodiment has reduced transition count of data and power consumption and the EMI noise by adopting C1 prefix coding and eliminating inter-word transitions.

### Eighth Embodiment

The eighth embodiment will apply the present invention to error correction codes. Here, a modified (7,4) Hamming code will be given as a new code. First, the (7,4) Hamming code is an Hamming code with code length of 7 and 4 information bits.

As mentioned above, in the embodiment, 23 code words are prepared related to quantization. For an actual TV image, however, 13 words up to ±124 are experimentally enough for R-G or B-G signals. Therefore, 4 bits (as information bits) are enough to encode.

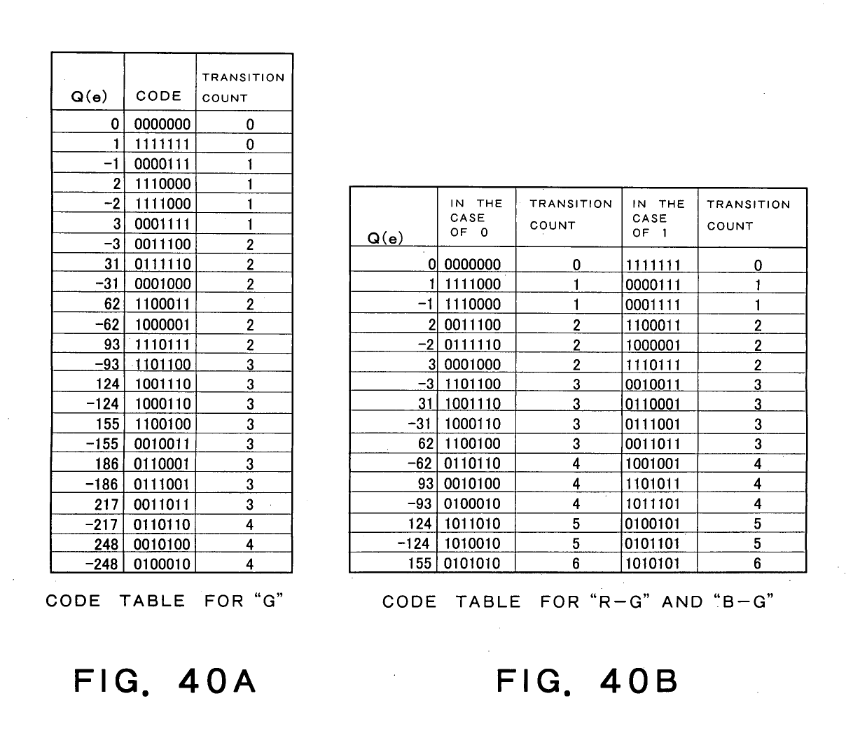

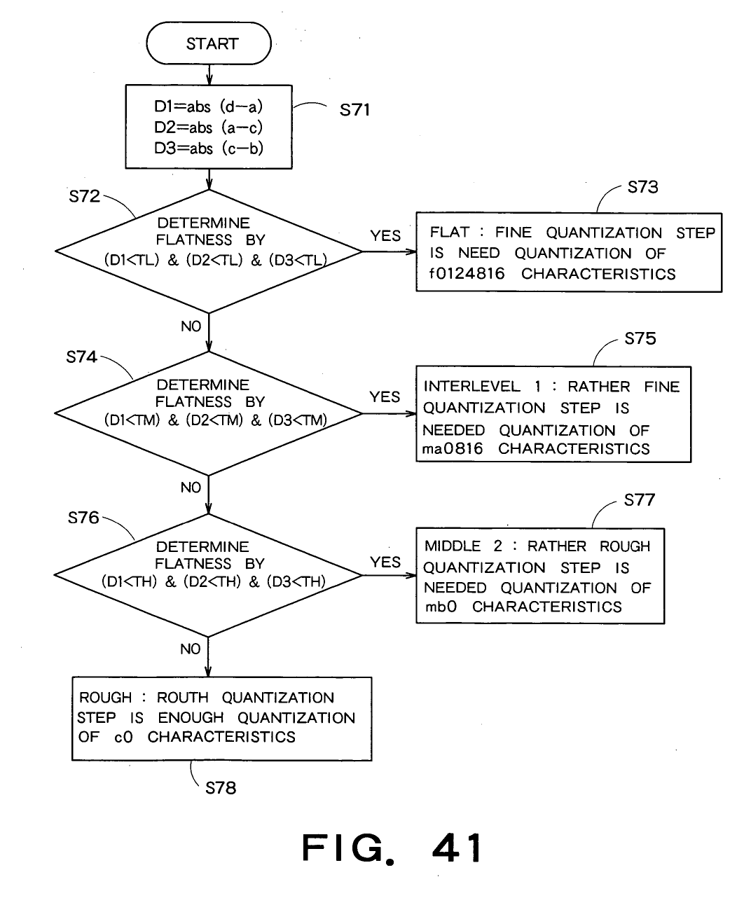

A code table relating to (R-G) or (B-G) of FIG. 40B should be prepared in order to transfer data. In the past, the allocation of Hamming code was performed regardless transition count. As described above, in the embodiment, allocation is started first from code word with smaller transition count (smaller transition count first). In order to reduce inter-word transition count, code word should be selected depending on the last bit of the previously transferred data. This is the same idea as the coding shown in FIG. 19.

Following will describe how to generate a pair of codes: append the bit inverted parity of the Hamming code as a new code word. For instance, “1110000” is usually given by appending the parity “000” for information “1110”. In addition, “1110111” is given by the appending the bit-inverted parity “111” for the information “1110”. The code word generated in this manner will be divided into two groups according to LSB: 0 or 1. The resultant codes will be allocated in the order of transition count (smaller count first). In such a manner, FIG. 40B has been constructed.

Next, a code table relating to G will be constructed. As data is fully distributed to the index “−248” for G, code word has shortage when constructing the G table in the same way as the R-G table and the B-G table. Therefore, reduction of inter-word transition count will be intentionally reconciled to forget: forget the code selection for “0” and “1” and prioritize the reservation of the total number of code. That is to say, use code word in (R-G) and (B-G) without code selection. Allocate codes staring from the data with smaller transition count. Actually, as shown in FIG. 40A, codes with up to 4 transitions counts are enough to use. In general, Hamming code has error correction capability. To enhance error correction capability more, especially to prevent the error undesirably occurred at the code selection bit, further redundant bit is intentionally appended.

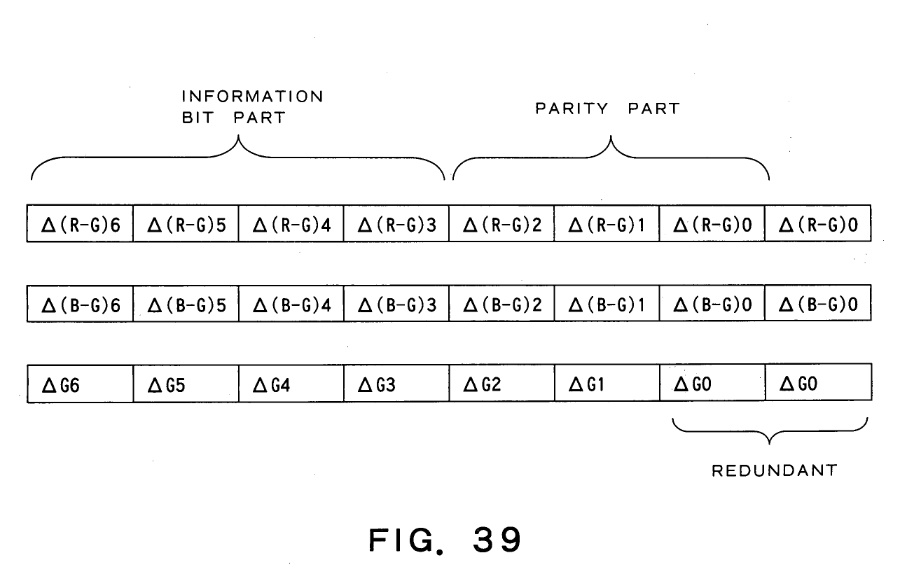

For this purpose, a transfer format of FIG. 39 is proposed. The bits Δ(R-G) 0, ΔG0, Δ(B-G) 0 related to code selection are all duplicated. As error correction capability is enhanced to such encoding, it is effective in higher operation frequency on noisy channel.

The “(7, 4) Hamming code” is a typical instance of error correcting code. So, error correction code is not limited to (7,4) Hamming code for our purpose. In most cases when designing error correction code, parity bits are appended: its bit length becomes longer than the original information. If quantization were not considered (that is, if you insisted on lossless coding), such idea would not be available because of the shortage of code word. The intentional allowance of degradation enhances the capability to suppress errors on a communication channel. The essence of the idea is the technique that the error-correction codes are reconstructed by a performance index such as transition count.

In summary, as described above, in the eighth embodiment, even when using error correction code, the reduction of transition count has been achievable for image data transmission.

### Ninth Embodiment

The ninth embodiment will especially improve the quantization characteristic determinator 14 shown in FIG. 1.

FIG. 41 is a flowchart showing an instance of the quantization characteristic determinator 14 according to the ninth embodiment. Different from the processing in FIG. 3, in FIG. 41 three thresholds TL, TM, and TH will select a quantization characteristic. The more options are given, the more adequately a quantization characteristic is selected according to the characteristic of image itself. This improves image quality further.

As an instance for the three thresholds, TL=16, TM=32, and TH=64 are exemplified here. The values are appropriately set according to the prioritization: whether image quality is prioritized or other performance (such as EMI reduction) is prioritized.

In FIG. 41, four quantization characteristics are used. There are four possible characteristics for G, and there are other four possible characteristics for both (R-G) and (B-G), resulting in totally eight possible characteristics at maximum. The phrase “at maximum” means that other four for both (R-G) and (B-G) may be identical to the four possible characteristics for G.

Here, we will describe an instance, which uses C1 prefix codes described in the previous seventh embodiment. Other coding or other compression code (such as the arithmetic code) is applicable as an instance.

The flowchart in FIG. 41 describes the processing of the quantization characteristic determinator 14 according to the embodiment. First, the differences D1, D2, and D3 are calculated (step S71). The step S71 is same as the step S1 of FIG. 3.

Next, determine a first context: whether all the absolute values of the three differences D1, D2 and D3 are less than TL, where TL is the first threshold (step S72). If the determination result is YES, context is determined to be flat (the first context), and select the fine step quantization (for instance, f0124816 characteristic) (step S73). At the step S73, perform the processing similarly to that in FIG. 4 (not identical): quantize difference data according to the quantization characteristic. If the difference is within ±0.5, the quantized difference data =0. If the difference is within the range [−1.5, −0.5] or [0.5, 1.5], the quantized difference data =1 or −1. If the difference is within the range [−2.5, −1.5] or [1.5, 2.5], the quantized difference data =2 or −2. If the difference is within the range [−5.5, −2.5] or [2.5, 5.5], the quantized difference data =4 or −4. If the difference is within the range [−10.5, −5.5] or [5.5, 10.5], the quantized difference data =8 or −8. If the difference is within the range [−21.5, −10.5] or [10.5, 21.5], the quantized difference data =16 or −16. Finally, if the difference is the other than those above, perform quantization with the step =32.

If the determination result at the step S72 is NO, determine a second context: whether all the absolute values of the difference D1, D2 and D3 are less than the second threshold TM (step S74). If the determination result is YES, the second context is selected: neither flat nor rough but an interlevel of them (middle 1), and perform quantization with rather fine step (for instance, ma0816 characteristic) (step S75). At the step S75, the following quantization is performed. If the difference is within the range [−3.5, 3.5], perform quantization with the quantized difference data =0. If the difference is within the range [−11.5, −3.5] or [3.5, 11.5], the quantized difference data =8 or −8. If the difference is within the range [−22.5-11.5] or [11.5, 22.5], the quantization data =16 or −16. Finally, if the difference is the other than those above, perform quantization with the step=32,.

If the determination result at the step S74 is NO, determine a third context: whether all the absolute values of the differences D1, D2 and D3 are less than the third threshold TH (step S76). If the determination result is YES, the third context is selected: neither flat nor rough but an interlevel of them (middle 2), and perform quantization with rather rough step (for instance, mb0 characteristic) (step S77). At step the S77, the following quantization is performed. If the difference is within [−14.5, 14.5], perform quantization with the difference data =0. Finally, if the difference is the other than those above, perform quantization with the step=32.

If the determination result at the step S76 is NO, the context is determined as the fourth context of “rough” because of no other choice: perform the quantization with rough quantization step (for instance, with c0 characteristic) at the step S78. The quantization characteristic is actually assumed as same as the interlevel 2 here, but it needs not to be same in general. The quantization has the prefix to denote context: “f” means flat context, “ma” means rather flat (middle 1), “mb” means rather rough context (middle 2), and “c” means rough context.

The step S78 contains two different quantization characteristics: (1) the characteristics where the processing in FIG. 41 is performed for green image data “G”, and (2) the characteristics where the processing in FIG. 41 is performed for image data (R-G), (B-G). The processing other than above is same.

The inventors have devised the above coding by using the well-known fact that difference data of natural images usually has the Laplace distribution. In the case of artificial images such as graphics, cartoons or the like, or even when with superficially 8-bit accuracy where essentially with MSB 6-bit accuracy, LSB is fixed to “00” in most cases. Assume generally that such an artificial image to have the Laplace distribution for instance. In this case, for the data near 0 such as ±1 or ±2 with sharply centered distribution, quantization error will increase to cause visible degradation of images as a result.

In order to improve image quality for such artificial images to avoid the above unwanted quantization error, quantization step should be intentionally matched to six-bit accuracy such as step of ±8. From this understanding, quantization steps ±8 and ±16 are intentionally used for the quantization characteristic at the step S73. Accordingly, for instance, the step unit “32” is more desirable than “31” even in rough quantization.

The quantization characteristics are not restricted to the described characteristics above which are selected at the steps S73, S75, S77 in FIG. 41. Various quantization characteristics can be selected as other options. The quantization characteristic needs not to be always static. For instance, an optimum quantization characteristic may be dynamically selected for each case: (1) a case when you aims at compression rate of ¼ while keeping image quality, (2) a case of a TIF image, (3) a case of a JPEG image, (4) a case of a MPEG image, or (5) a case of a PC screen image. In order to perform such dynamic selection of quantization characteristic, you may need some mechanism just to detect the shape of difference distribution. The receiving side (source driver) not necessarily must detect the shape of distribution. As an alternative, the transmitting side (timing controller) may possibly send detected result as a flag before sending image data: the receiving side (source driver) receives the flag at first, then selects the quantization characteristic based on the flag. The shape of distribution can be determined as another approach: determine the context whether the occurrence frequency is higher or lower than a certain given threshold. As smaller hardware is desirable, there is no necessity to monitor all gradation level for this determination: it is enough to just determine steepness of the distribution in some way without such monitoring.

In summary, as described above in the ninth embodiment, since a value of difference image data has selected the quantization characteristic more finely, the ninth embodiment has transmitted image data with keeping better image quality.

### Tenth Embodiment

The tenth embodiment will reconstruct the C1 prefix code to other modified C1 prefix code by multi-valuation (3-valuation). The similar discussion holds for reconstructing the codes: multi-valuation of other compression codes such as the Hamming code, the arithmetic code, the Golomb code or the like.

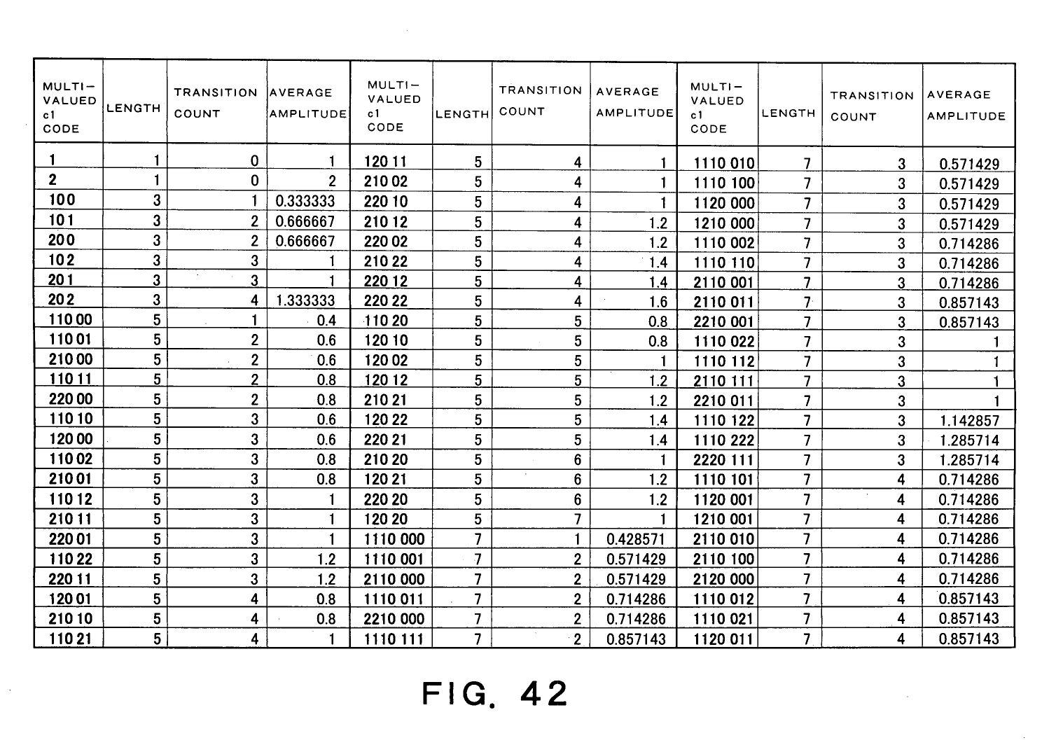

FIG. 42 is a code table, which partially shows the multi-valued C1 prefix code. The C1 prefix codes in FIG. 42 are 3-valued C1 prefix codes with length up to 7. Similar to the above code word construction, sort some code words first with better performance. Code words are sorted in the order of prioritized indices: code length, transition count and average amplitude. FIG. 42 is merely an instance: they can be re-sorted with the different prioritization for already-existing indices, otherwise re-sorted with any other new indices. Here in this code design, “0” is used in order to detect prefix. For alternative code design, “1” and “2” are available to play the same detecting role.

By using the multi-valued C1 prefix codes shown in FIG. 42, high quality is kept for images and their compression rate are improved at the same time. Such compression has some options to reduce width of lines and to slowdown operating frequency as follows.

For instance, when a compression capability factor is 4, there is a first option to reduce width of lines to ¼ (no encoding), and a second option to slow down operating frequency to ½ with reducing the width of lines to ½. Even when the width of lines is reduced to ¼, its average transition count is reduced to 0.17-1.14 from 4 (no encoding), thereby it still has reducing capability on its EMI noise. When width of lines is reduced to ½, its operating frequency is slow downed to ½ and its EMI noise is reduced to ¼, i.e. ¼*(0.17-1.14)*¼=0.01-0.07: thereby EMI noise has further reduced. In this case, the width of lines is doubled. In this way, there are such trade-offs in general.

In summary, in the tenth embodiment, the multi-valued C1 prefix code has improved image quality and has reduced the width of transmitting lines 3 and so on.

Then as final review, our advantages will be concluded. The encoders 13 of the first to the tenth embodiment mentioned above have achieved the reduction of average amplitude or EMI noise etc. with allowing degradation of images by the code tables in considering signal amplitude, transition count, code length. The encoders have also simultaneously reduced width of lines. One embodiment has also reduced level of multi-valuation in transmitting. Another embodiment has also improved the S/N ratio at discrimination point on receiving side and yet another embodiment has enhanced further capability such as add-on error correction. The introduction of quantization has improved performances (reduction of average amplitude, EMI noise, and power consumption). The quantization has provided the flexibility to select code words, which enhances other capability than size reduction. In this sense, each embodiment has performed more advantageous encoding than conventional lossy compression coding which focuses only on reduction of data size.

What is claimed is:

1. An image transmission apparatus comprising:
a difference calculator configured to calculate a difference between actual image data and current predicted data based on previous data;
a quantizer configured to generate quantized difference data obtained by quantizing the difference;
a quantization characteristic determinator configured to determine a quantization characteristic corresponding to the quantizer based on pixel values of a plurality of neighbor pixels located in surroundings of a current pixel; and
a encoder configured to generate code word to be transmitted via a least single transmission line based on the quantized difference data.

2. The image transmission apparatus according to claim 1,
wherein the quantization characteristic determinator determines one among a plurality of quantization characteristics each having different step for quantization.

3. The image transmission apparatus according to claim 2,
wherein the quantizer quantizes the difference based on the step in accordance with the quantization characteristic determined by the quantization characteristic determinator.

4. The image transmission apparatus according to claim 1,
wherein the quantization characteristic determinator includes:
a surrounding pixel difference detector configured to detect the difference between pixel values of a plurality of neighbor pixels located in surroundings of the current pixel; and
a quantization characteristic selector configured to select one of the plurality of quantization characteristics depending on whether at least one of the difference detected by the surrounding pixel difference detector exceeds a given threshold.

5. The image transmission apparatus according to claim 2,
wherein the encoder generates the code word independently with respect to each of the plurality of quantization characteristics.

6. The image transmission apparatus according to claim 1, further comprising:
a image reconstructor which generates reconstructed image data by adding the quantized difference data to the predicted data; and
a predictor which generates the predicted data, based on the reconstructed image data.

7. The image transmission apparatus according to claim 1,
wherein the encoder generates the code word in which at least one of an average amplitude and the average transition count of the code word becomes minimum based on the quantized difference data.

8. The image transmission apparatus according to claim 1,
wherein the encoder preferentially allocates the code word having smaller average amplitude or the smaller average transition count to the quantized difference data having a smaller value.

9. The image transmission apparatus according to claim 1,
wherein the encoder generates final code word by removing the code word having a digit of larger amplitude than a specified level.

10. The image transmission apparatus according to claim 1, further comprising a modulo unit configured to calculate modulo data corresponding to a remainder obtained by dividing the code word generated by the encoder by a integer “two”,
wherein the modulo data is applied to the transmission line as final code word.

11. The image transmission apparatus according to claim 1,
wherein the encoder generates the code word by using Golomb code, arithmetic code or Huffman code, taking into consideration at least one of average amplitude and the average transition count.

12. The image transmission apparatus according to claim 1,
wherein the encoder generates the code word by using C1 prefix code.

13. The image transmission apparatus according to claim 1,
wherein the encoder generates the code word by using Hamming code.

14. An image receiving apparatus, comprising:
a decoder configured to receive code word transmitted via at least single transmission line, perform decoding process and generate quantized difference data;
an inverse quantizer configured to calculate a difference between actual image data and predicted data predicted by reconstructed image data corresponding to the actual image data based on the quantized difference data;
an inverse quantization characteristic determinator configured to determine inverse quantization characteristic by the inverse quantizer based on pixel values of a plurality of neighbor pixels located in surroundings of a current pixel; and
a image reconstructor configured to generate the reconstructed image data based on the difference.

15. The image receiving apparatus according to claim 14, further comprising a predictor configured to generate the predicted data based on the reconstructed image data,
wherein the image reconstructor generates the reconstructed image data by adding the difference calculated by the inverse quantizer to the predicted data.

16. The image receiving apparatus according to claim 14,
wherein the inverse quantization characteristic determinator determines one among a plurality of inverse quantization characteristics each having different step for quantization.

17. The image receiving apparatus according to claim 16,
wherein the inverse quantizer calculates the difference based on step in accordance with the inverse quantization characteristic determined by the inverse quantization characteristic determinator.

18. The image receiving apparatus according to claim 14,
wherein the inverse quantization characteristic determinator includes:
a surrounding pixel difference detector configured to detect the difference of the pixel values between a plurality of neighbor pixels located in surroundings of the current pixel; and
an inverse quantization characteristic selector configured to select one among a plurality of inverse quantization characteristics depending on whether at least one of the difference detected by the surrounding pixel difference detector exceeds a given threshold.

19. An image transmission method which transmits image data from an image transmission apparatus to an image receiving apparatus, comprising:
calculating a difference between actual image data and current predicted data based on previous data;
generating quantized difference data obtained by quantizing the difference based on quantization characteristic determined based on pixel values of a plurality of neighbor pixels located in surroundings of a current pixel;
generating code word to be transmitted via at least single transmission line based on the quantized difference data;
determining an inverse quantization characteristic based on pixel values of a plurality of neighbor pixels located in surroundings of the current pixel to convert the quantized difference data to a difference between actual image data and predicted data predicted by reconstructed image data corresponding to the actual image data,
wherein the reconstructed image data is generated based on the difference.

20. The image transmission method according to claim 19,
wherein the reconstructed image data is generated by adding the quantized difference data to the predicted data; and
the predicted data is generated based on the reconstructed image data.
